(19) United States
(12) Patent Application Publication
(10) Pub. No.: US 2025/0085207 A1
(43) Pub. Date: Mar. 13, 2025

(54) METHOD FOR PREDICTING PERMEABILITY ACCORDING TO GEOMETRICAL CHANGE IN POROUS MEDIUM ON BASIS OF SUPERFICIAL EFFECTIVE DIAMETER

(71) Applicant: KOREA GAS CORPORATION, Daegu (KR)

(72) Inventor: Chang Hoon SHIN, Suwon-si Gyeonggi-do (KR)

(73) Assignee: KOREA GAS CORPORATION, Daegu (KR)

(21) Appl. No.: 18/925,544

(22) Filed: Oct. 24, 2024

Related U.S. Application Data
(63) Continuation of application No. PCT/KR2022/007218, filed on May 20, 2022.

(30) Foreign Application Priority Data
May 20, 2022 (KR) 10-2022-0061804

(51) Int. Cl. G01N 15/08

(52) U.S. Cl. CPC G01N 15/08

(57) ABSTRACT

Provided a method for predicting permeability according to the geometrical change in a porous medium on the basis of a superficial effective diameter, wherein the permeability according to geometrical changes in the porous medium is precisely predicted. The method for predicting permeability according to geometric change in the porous medium comprises: providing a porous medium; obtaining first porosity and first permeability at a plurality of points of the porous medium, respectively; calculating a first superficial effective diameter using the first porosity and the first permeability; establishing a first correlation between the first porosity and the first superficial effective diameter, a second correlation between the first permeability and the first superficial effective diameter, and a third correlation between the first porosity and the first permeability; and using the correlations to predict a second permeability for a second porosity changed by a geometrical change in the porous medium.

### CROSS-REFERENCE TO RELATED APPLICATIONS

This application is a continuation of International Application No. PCT/KR2022/007218 filed on May 20, 2022, which claims priority to Korean Patent Application No. 10-2022-0061804 filed on May 20, 2022, the entire contents of which are herein incorporated by reference.

### FIELD OF INVENTION

The present invention relates to method for analysing flow in a porous medium, and more particularly, method for predicting permeability according to geometrical change in a porous medium on basis of superficial effective diameter.

The present invention is proposed with reference to Energy Resource Convergence Source Technology Development Project No. 20132510100060 and No. 20172510102150 supported by the Korea Institute of Energy Technology Evaluation and Planning (KETEP), granted financial resource from the Ministry of Trade, Industry & Energy, Republic of Korea.

### BACKGROUND OF INVENTION

In the development and production process of general oil/gas fields, friction flow analysis and permeability estimation are key factors that most directly affect the production volume and furthermore the reserves of oil and gas. In particular, the recent development of shale gas or tight oil centered on the US and Canada has a large geometric change in the first 2-3 years of production, so the changes in permeability and productivity are very rapid and uncertain, which ultimately determines the economic feasibility of oil and gas development and production projects.

Permeability is usually predicted by assuming a correlation with porosity, for example, a correlation based on a power-law equation. However, these power-law equations inherently have a characteristic of having a steep change slope in actual reservoir rocks with a low porosity range and complex pore structures, so their reliability and accuracy are greatly reduced when applied to actual oil and gas fields. As such, it is difficult to present an appropriate application (interpolation) method for expansion to other production wells around the same mine or stratum, as well as reliability constraints due to production in the same well, so it is true that there are limitations in reliable application in actual oil and gas field development.

### PRIOR ART LITERATURE

Bear, J., “Dynamics of fluids in porous media,” (American Elservier Pub. Inc., 1975), p. 27-194.
Ergun, S., “Fluid flow through packed columns,” (Chemical Engineering Progress, 1952) p.89-94.
Rigden, P. J., “Flow of fluids through porous plugs and the measurement of specific surface,” Nature 157, 268-268 (2016).
Shin, C., “Permeability variations by changes in geometrical conditions,” Phys. Fluids 31, 023104 (2019).
Berkowitz, B., “Characterizing flow and transport in fractured geological media: a review,” Advances in Water Resources 25, 861-884 (2002).
Walsh, J. B. & Brace, W. F., “The effect of pressure on porosity and the transport properties of rock,” J. Geophysical Research89 (B11), 9425-9431 (1984).
Jeon, P. R. & Lee, C. H., “Effect of surfactant on CO₂ solubility and reaction in CO₂-brine-clay mineral systems during CO₂ enhanced fossil fuel recovery,” Chem. Eng. J. 382, 123014 (2020).
Snaebjornsdorrir, S. O., Sigfusson, B., Mariene, C. et al., “Carbon dioxide storage through mineral carbonation,” Nat. Rev. Earth Environ. 1, 90-102 (2020).
Liu, H. L. & Hwang, W. R., “Permeability prediction of fibrous porous media with complex 3D architectures,” Composites Part A 43, 2030-2038 (2012).
Wang, P., Huang, P., Xu, N., Shi, J. & Lin, Y. S., “Effects of sintering on properties of alumina microfiltration membranes,” J. Membr. Sci. 155, 309-314 (1999).
Nemeca, D. & Levec, J., “Flow through packed bed reactors: 1. Single-phase flow,” Chem. Eng. Sci. 60, 6947-6957 (2005).
Karimian, S. A. M. & Straatman, A. G., “CFD study of the hydraulic and thermal behavior of spherical-void-phase porous mediums,” Int. J. of Heat and Fluid Flow 29, 292-305 (2008).
Vogel, H. J., “A numerical experiment on pore size, pore connectivity, water retention, permeability, and solute transport using network models,” European J. Soil Science 51 (1), 99-105 (2000).
Han, Y. S., Kwak, D. W., Choi, S. Y., Shin, C. H., Lee, Y. S. & Kim, H. J., “Pore Structure Characterization of Shale Using Gas Physisorption: Effect of Chemical Compositions,” Minerals 7:66 (2017).
Ali, S. A. S., Azarpeyvand, M., Szoke, M. & da Silva, C. R. I., “Boundary layer flow interaction with a permeable wall,” Phys. Fluids 30, 085111 (2018).
Zhou, B., Jiang, P., Xua, R. & Ouyang, X., “General slip regime permeability model for gas flow through porous media,” Phys. Fluids 28, 072003 (2016).
Kozeny, J. Ueber kapillare leitung des wassers im boden., “Sitzungsberichte der Akademie der Wissenschaften in Wien,” 136, 271-306 (1927).
Carman, P. C., “The determination of the specific surface of powders,” Trans. J. Soc. Chem. Ind. 57 (225), 225-234 (1938).
Archie, G. E., “The electrical resistivity log as an aid in determining some reservoir characteristics,” Trans. Am. Inst. Mech. Eng. 146, 54-67 (1942).
Achdou, Y. & Avelaneda, M., “Influence of pore roughness and pore-size dispersion in estimating the permeability of a porous medium from electrical measurements,” Phys. Fluids A: Fluid Dynamics 4, 2651-2673 (1992).
Kochanski, J., Kaczmarek, M. & Kubik, J., “Determination of permeability and tortuosity of permeable media by ultrasonic method. Studies for sintered bronze,” J. of Theoretical and Applied Mechs. 1 (39), 923-928 (2000).
Matyka, M., Khalili, A. & Koza, Z., “Tortuosity-porosity relation in porous media flow,” Phys. Rev. E. 78, 026306 (2008).
Valdes-Parada, F. J., Porter, M. L. & Wood, B. D., “The Role of Tortuosity in upscaling,” Transp. Porous Media 88, 1-30 (2011).
Ahmadi, M. M., Mohammadi, S. & Hayati, A. N., “Analytical derivation of tortuosity and permeability of monosized spheres: A volume averaging approach,” Phys. Rev. E.83, 026312 (2011).
Sobieski, W., Zhang, Q. & Liu, C., “Predicting tortuosity for airflow through porous beds consisting of randomly packed spherical particles,” Transp. in Porous Media 93 (3), 431-451 (2012).
Shin, C., “Tortuosity correction of Kozeny's hydraulic diameter of a porous medium,” Phys. Fluids 29, 023104 (2017).
Lanfrey, P. Y., Kuzeljevic, Z. V. & Ducukovic, M. P., “Tortuosity model for fixed beds randomly packed with identical particles,” Chem. Eng. Sci. 65 (5), 1891-1896 (2009).
Dullien, F. A. L., “Single phase flow through porous media and pore structure,” Chem. Eng. J. 10, 1-34 (1975).
Yu, A. B., Zou, R. P. & Standish, N., “Modifying the linear packing model for predicting the porosity of non-spherical particles mixtures,” Ind. Chem. Res. 35, 8730-3741 (1996).
Ozugumus, T., Mobedi, M. & Ozkai, U., “Determination of Kozeny constant based on porosity and pore throat size ratio in porous medium with rectangular rods,” Eng. App. Comp. Fluid Mech. 8 (2), 308-318 (2014).
Xu, P. & Yu, B., “Developing a new form of permeability and Kozeny-Carman constant for homogeneous porous media by means of fractal geometry,” Advances in Water Resources 31, 74-81 (2008).
Heijs, A. W. J. & Lowe, C. P., “Numerical evaluation of the permeability and the Kozeny constant for two types of porous media,” Phys. Rev. E 51, 4346-4352 (1995).
Gamrat, G., Favre-Marinet, M. & Le Person, S., “Numerical study of heat transfer over banks of rods in small Reynolds number cross-flow,” Int. J. of Heat and Mass Transfer 51, 853-864 (2008).
White, F. M., “Fluid dynamics,” 4th ed., (McGraw-Hill, New York, 2001) p. 325-404.

### SUMMARY OF INVENTION

### Technical Problem to be Solved

A technical task to be achieved by the technical idea of the present invention is to provide provides a method for predicting permeability according to geometrical change in a porous medium on basis of superficial effective diameter which can accurately predict permeability according to geometrical change in a porous medium.

However, the scope of the present invention is not limited thereto.

### Technical Solution

According to an aspect of the present invention, there is provided a method for predicting permeability according to geometrical change in a porous medium may include providing a porous medium; obtaining a first porosity and a first permeability at the plurality of points of the porous medium, respectively; calculating a first superficial effective diameter using the first porosity and the first permeability; establishing a first correlation between the first porosity and the first superficial effective diameter, a second correlation between the first permeability and the first superficial effective diameter, and a third correlation between the first porosity and the first permeability; and predicting a second permeability for a second porosity changed by a geometric change of the porous medium using the correlations.

According to one embodiment of the present invention, the predicting a second permeability may include, calculating a second superficial effective diameter for the second porosity using the first correlation; and calculating a second permeability for the second superficial effective diameter using the second correlation.

According to one embodiment of the present invention, the first porosity, the first permeability, and the first superficial effective diameter may satisfy the following equations:

$$∴ k = \frac{Φ \cdot {D}_{e}^{2} \cdot {T}^{2}}{32}$$

$$or$$

$$k = \frac{Φ \cdot \overline{{D}_{e}} {}^{2}}{32}$$

where k is permeability, φ is porosity, Dₑ is an effective diameter, T is hydraulic tortuosity, D̅ₑ̅ and is a superficial effective diameter.

According to one embodiment of the present invention, the first superficial effective diameter may satisfy the following equation:

$$\overline{{D}_{e}} = {D}_{e} \cdot T = {D}_{h} \cdot {( \frac{T}{ξ} )}^{\frac{1}{2}}$$

where D̅ₑ̅ is a superficial effective diameter, Dₑ is an effective diameter, T is hydraulic tortuosity, Dₕ is a hydraulic diameter, and ξ is a friction ratio.

According to one embodiment of the present invention, the effective diameter may satisfy the following equation:

$${D}_{e} = \frac{{D}_{h}}{{( T \cdot ξ )}^{0.5}}$$

where Dₑ is an effective diameter, Dₕ is a hydraulic diameter, T is hydraulic tortuosity, and ξ is a friction ratio.

According to one embodiment of the present invention, the friction ratio may satisfy the following equations:

$$ξ = \frac{{f}_{υ}}{{f}_{e}} \frac{{Re}_{υ}}{{Re}_{e}} = \frac{{f}_{υ} {Re}_{v}}{64} ∵ {f}_{υ} {Re}_{e} ≡ 64$$

where fᵥ is a friction factor based on v, Reᵥ is a Reynolds number based on v, fₑ is a friction factor based on vₑ, Reₑ is a Reynolds number based on vₑ, v is an interstitial flow velocity, and vₑ is an effective interstitial flow velocity.

According to one embodiment of the present invention, the fₑ and the Reₑ may satisfy the following equations:

$${f}_{e} = \frac{2 {D}_{e}}{{ρ}^{{υ}^{2}}} \frac{Δ P}{{L}_{e}} ,$$

$${Re}_{e} = \frac{ρ υ {D}_{e}}{μ}$$

where Dₑ is an effective diameter, ρ is a fluid density, v is an interstitial flow velocity, ΔP is pressure difference, Lₑ is an actual pore flow length, and μ is a fluid viscosity.

According to one embodiment of the present invention, the interstitial flow velocity and the effective interstitial flow velocity satisfy the following equations:

$$υ = - \frac{2 {D}_{h}^{2}}{μ \cdot {f}_{υ} {Re}_{υ}} \frac{Δ P}{L}$$

$${υ}_{e} = - \frac{2 {D}_{e}^{2}}{μ \cdot {f}_{e} {Re}_{e}} \frac{Δ P}{{L}_{e}}$$

where v is an interstitial flow velocity, Dₕ is a hydraulic diameter, μ is a fluid viscosity, fᵥ is a friction factor based on v, Reᵥ is a Reynolds number based on v, ΔP is pressure difference, L is a porous medium length, vₑ is an effective interstitial flow velocity, Dₑ is an effective diameter, fₑ is a friction factor based on vₑ, Reₑ is a Reynolds number based on vₑ, and Lₑ is an actual pore flow length.

According to one embodiment of the present invention, the first permeability may satisfy the following equation:

$$k = \frac{2 {D}_{h}^{2} \cdot Φ T}{{f}_{υ} {Re}_{υ}} = \frac{Φ \cdot {D}_{h}^{2}}{32} \cdot ( \frac{T}{ξ} )$$

where k is permeability, Dₕ is a hydraulic diameter, φ is porosity, T is hydraulic tortuosity, v is an interstitial flow velocity, fᵥ is a friction factor based on v, Reᵥ is a Reynolds number based on v, and ξ is a friction ratio.

According to one embodiment of the present invention, the first correlation between the first superficial effective diameter and the first porosity may have a quadratic functional correlation.

According to one embodiment of the present invention, the second correlation between the first permeability and the first superficial effective diameter may have a power-law functional correlation, and the third correlation between the first porosity and the first permeability may have a power-law functional correlation.

According to one embodiment of the present invention, the obtaining the first porosity and the first permeability may be performed under a condition that the following equations are satisfied:

$$∴ Δ {P}_{Φ} \approx {C}_{{dp}_{( A )}}^{\frac{1}{Φ}} ∴ {C}_{dp} = Δ {P}^{Φ} \approx constant \& {C}_{{dp}_{( A )}} : {C}_{dp} of each initial status \qquad ( a )$$

$$∴ {υ}_{Φ} \approx \frac{{C}_{{υ}_{( A )}}}{{Φ}^{0.5}} ∵ {C}_{υ} = υ \cdot {Φ}^{0.5} \approx constant \& {C}_{{υ}_{( A )}} : {C}_{υ} of each initial status \qquad ( b )$$

where ΔP_{φ} is pressure difference, v_{φ} is an interstitial flow velocity, C_{dP} is a pressure difference constant, and Cᵥ is an interstitial flow velocity constant.

According to one embodiment of the present invention, the first porosity may have a range of 13.4% to 47.4%, and the first permeability has a range of 0.0073 Darcy to 18.3 Darcy.

According to one embodiment of the present invention, a quadratic function interpolation method for the first correlation between the first porosity and the first superficial effective diameter may be performed to obtain family medium correlations between a porosity and a superficial effective diameter for a family medium of the porous medium.

According to an aspect of the present invention, there is provided a method for predicting permeability according to geometrical change in a porous medium may include: providing a porous medium; providing a porous medium model for the porous medium having porosity due to the arrangement of grains; performing a pore-scale simulation for the porous medium model to calculate a porosity, a permeability and a superficial effective diameter; establishing a fourth correlation between the porosity and the superficial effective diameter, a fifth correlation between the permeability and the superficial effective diameter, and a sixth correlation between the porosity and the permeability; and calculating a superficial effective diameter from a porosity of a porous medium to be predicted using the fourth correlation, and predicting a permeability of the porous medium to be predicted from the superficial effective diameter of the porous medium to be predicted using the fifth correlation.

According to one embodiment of the present invention, in the performing a pore-scale simulation, the pore-scale simulations may be performed with respect to a first direction in the porous medium model and a second direction in the porous medium model perpendicular to the first direction, respectively, to calculate the porosity, the permeability, and the superficial effective diameter with respect to first direction and the second direction, respectively, wherein in the establishing the fourth correlation, the fourth correlation is established with respect to the first direction and the second direction, respectively, wherein in the establishing the fifth correlation, the fifth correlation is established with respect to the first direction and the second direction, respectively, wherein in the establishing the sixth correlation, the sixth correlation is established with respect to the first direction and the second direction, respectively.

According to one embodiment of the present invention, the establishing the fourth correlation may include establishing a fourth reference correlation corresponding to the average of the fourth correlation with respect to the first direction and the fourth correlation with respect to the second direction, the establishing the fifth correlation may include establishing a fifth reference correlation corresponding to the average of the fifth correlation with respect to the first direction and the fifth correlation with respect to the second direction, and the establishing the sixth correlation may include establishing a sixth reference correlation corresponding to the average of the sixth correlation with respect to the first direction and the sixth correlation with respect to the second direction.

According to one embodiment of the present invention, a quadratic function interpolation method with respect to the fourth reference correlation may be performed to further establish the fourth correlation to be extended in multiple ways with respect to the change in the porosity.

According to one embodiment of the present invention, the porous medium model may consist of a simple porous medium model in which grains of equal size are arranged, wherein the grains have a radius in a range of 45 μm to 55 μm, wherein the simple porous medium model has a crack height in a range of 0.4 mm to 0.5 mm and porosity in a range of 36% to 47.5%.

According to one embodiment of the present invention, the porous medium model may consist of a complex porous medium model in which grains of different sizes are arranged, wherein the grains of different sizes are arranged staggered with each other, wherein the grains has a radius in a range of 30 μm to 55 μm, wherein the complex porous medium model has a crack height in a range of 0.4 mm to 0.5 mm and porosity in a range of 13.3% to 22.6%.

### Advantageous Effects

In the method for predicting permeability according to geometric changes in a porous medium on basis of superficial effective diameter according to the present invention, an effective diameter of a porous medium is newly defined, and an equivalent flow model of the porous medium is defined by combining it with the conventional concept of hydraulic tortuosity of Kozeny. Through this, the porous friction flow characteristics such as the Darcy friction coefficient, Reynolds number, and friction constant, which are the most important characteristic variables in internal friction flow analysis, can be rigorously determined. Therefore, the characteristic variables based on this equivalent flow model can be utilized in various practical related analysis and engineering fields in the future.

In addition, the present invention improves the interpretation of permeability as a power-law function of porosity in the past to propose a new theory that permeability is defined based on the superficial effective diameter, and the superficial effective diameter is defined as a quadratic function of porosity, thereby suggesting a technique that can enhance the reliability of permeability change analysis and improve expandability.

In particular, by deriving an approximate relationship for the correlation between a geometric change, a pressure change, and an interstitial flow velocity, it is expected to play a significant role in securing economic feasibility and stability in the development and progress of related fields in the future.

The equivalent flow model based on the effective diameter and the superficial diameter based relational expressions that are extended from it presented in the present invention provide a completely rigorous theoretical correlation for the reservoir flow, and its usability is further enhanced by suggesting an interpolation method of the superficial diameter based on a simple parallel translation method. In particular, approximate relations for the correlations among geometric changes, pressure changes, and interstitial flow velocity are presented.

Accordingly, when the theory of the present invention is applied to the development/production of actual oil/gas fields (especially shale/tight strata), more reliable and scalable results can be expected. In particular, it is expected to contribute to improving the economic feasibility of related businesses and strengthening their technological status by enabling the estimation of oil/gas reserves, optimal well development plans, and appropriate production facility investment and operating costs.

The above-described effects are merely examples and the scope of the present invention is not limited thereto.

### BRIEF DESCRIPTION OF DRAWINGS

FIG. 1 is a schematic diagram showing hydraulic variables and effective variables based on a cylindrical medium in the method for predicting permeability according to geometrical change in a porous medium, according to an embodiment of the present invention.

FIG. 2 shows a simple porous medium model for pore-scale simulation in the method for predicting permeability according to geometrical change in a porous medium, according to an embodiment of the present invention.

FIG. 3 shows a complex porous medium model for pore-scale simulation in the method for predicting permeability according to geometrical change in a porous medium, according to an embodiment of the present invention.

FIG. 4 is a table showing key geometric shape information for performing the pore-scale simulation of the simple porous medium model in the method for predicting permeability according to geometrical change in a porous medium, according to an embodiment of the present invention.

FIG. 5 is a table showing key pore-scale simulation results of a flat plate model in the method for predicting permeability according to geometrical change in a porous medium, according to an embodiment of the present invention.

FIG. 6 is a table showing key geometric shape information for performing the pore-scale simulation of the complex porous medium model in the method for predicting permeability according to geometrical change in a porous medium, according to an embodiment of the present invention.

FIGS. 7 and 8 show streamline distributions derived from the pore-scale simulation results for the simple porous medium model in the method for predicting permeability according to geometrical change in a porous medium, according to an embodiment of the present invention.

FIGS. 9 and 10 show streamline distributions derived from the pore-scale simulation results for the complex porous medium model in the method for predicting permeability according to geometrical change in a porous medium, according to an embodiment of the present invention.

FIGS. 11 through 13 show enlarged streamline distributions derived from the pore-scale simulation results for the porous medium model in the method for predicting permeability according to geometrical change in a porous medium, according to an embodiment of the present invention.

FIG. 14 is a table showing variables derived from the pore-scale simulation results in the method for predicting permeability according to geometrical change in a porous medium, according to an embodiment of the present invention.

FIGS. 15 through 27 are graphs showing correlations of variables obtained from the pore-scale simulations in the method for predicting permeability according to geometrical change in a porous medium, according to an embodiment of the present invention.

FIG. 28 is a table showing pressure difference constant and interstitial flow velocity constant for interstitial flow velocity in the method for predicting permeability according to geometrical change in a porous medium, according to an embodiment of the present invention.

FIGS. 29 and 30 are flowcharts of a method for predicting permeability according to geometrical change in a porous medium, according to an embodiment of the present invention.

### DETAILED DESCRIPTION OF PREFERRED EMBODIMENTS OF INVENTION

Hereinafter, preferred embodiments of the present invention will be described in detail with reference to the accompanying drawings. The embodiments of the present invention are provided to more completely explain the technical idea of the present invention to those skilled in the art, and the following examples may be modified in various different forms, and the scope of the technical idea is not limited to the following examples. Rather, these embodiments are provided so that this disclosure will be thorough and complete, and will fully convey the spirit of the invention to those skilled in the art. Like reference numerals throughout this specification mean like elements. Furthermore, various elements and areas in the drawings are schematically drawn. Therefore, the technical spirit of the present invention is not limited by the relative size or spacing drawn in the accompanying drawings.

The frictional flow features associated with porous media are becoming increasingly important for driving environmentally friendly operations and economically viable industrial applications such as groundwater, oil, and gas production and the development of purification filters, ceramic membranes, and metal foam materials. Herein, permeability characterization is an essential part of hydrocarbon recovery, carbon capture and geological sequestration, nuclear waste disposal, carbonate reservoir stimulation, and contaminant remediation in groundwater.

In shale gas and tight oil formations, production and injection wells must be designed considering the flow rate changes and pore volume (aperture) alterations that can be attributed to the changes in formation stress because permeability or aperture is continuously changing owing to the fluid productions from each formation. In carbon capture storage and nuclear waste disposal, any increased permeability due to formation stress changes may induce movements of carbon dioxide or radioactive substances through ground water or fluids in each formation. Therefore, evaluation of permeability and its variation is critical for any future formation stress changes caused by fluid injection or production.

Fundamentally, permeability (k) is determined via Darcy's equation on measured pressure difference (ΔP) and apparent flow velocity (u). The Darcy's equation is shown in Equation 1, as follows.

$$\begin{matrix}〈 Equation 1 〉 & \\ u = - \frac{k}{μ} \frac{Δ P}{L} & \end{matrix}$$

$$and$$

$$k = \frac{2 {D}_{h}^{2}}{{f}_{u} {Re}_{u}}$$

$$and where$$

$${f}_{u} = \frac{2 {D}_{h}}{ρ {u}^{2}} \frac{Δ P}{L}$$

$$and$$

$${Re}_{u} = \frac{ρ {uD}_{h}}{μ} \vert$$

In Equation 1, u is a flow velocity, k is permeability, μ is a fluid viscosity, ΔP is pressure difference, L is a porous medium length, Dₕ is a hydraulic diameter, fᵤ is a friction factor based on u, Rᵤ is a Reynolds number based on u, and ρ is a fluid density.

Alternatively, as shown in Equation 2, the Kozeny-Carman equation can be used, which is based on geometric variables, including a hydraulic diameter and hydraulic tortuosity. Here, the hydraulic diameter (Dₕ) can be expressed by a relation of Dₕ=4φ/Sₛ. The hydraulic tortuosity (T) is defined as a ratio of the porous medium length (L) to the actual pore flow path (Lₑ), and can be expressed by a relation of T=L/Lₑ.

$$\begin{matrix}〈 Equation 2 〉 & \\ u = - \frac{Φ}{μ} ( \frac{{D}_{h}^{2}}{16 {C}_{K}} ) ( \frac{Δ P}{L} ) {( \frac{L}{{L}_{e}} )}^{2} = Φυ {T}^{2} & ( a )\end{matrix}$$

$$where$$

$${T}^{2} = {( \frac{L}{{L}_{e}} )}^{2} = \frac{u}{Φ υ}$$

$$∴ {k}_{C} = \frac{{D}_{h}^{2} \cdot Φ {T}^{2}}{16 {C}_{K}} \qquad ( b )$$

$$or$$

$${k}_{C} = \frac{{Φ}^{3}}{{S}_{S}^{2}} ( \frac{{T}^{2}}{{C}_{K}} )$$

$$where$$

$${D}_{h} \frac{4 Φ}{{S}_{S}} = \frac{4 {D}_{m} Φ}{{C}_{S} ( 1 - Φ )} = 4 {R}_{h}$$

In Equation 2, u is a flow velocity, φ is porosity, μ is a fluid viscosity, Dₕ is a hydraulic diameter, C_{K} is a Kozeny constant, ΔP is pressure difference, L is a porous medium length, Lₑ is an actual pore flow length, T is hydraulic tortuosity, v is an interstitial flow velocity, k_{C} is Carman permeability, S_{S} is a specific surface area, Dₘ is a grain diameter, C_{S} is a cross section shape constant, and Rₕ is a hydraulic diameter.

However, in reality, hydraulic tortuosity cannot be precisely determined in a reliable manner because it can only be obtained from either actually immeasurable the average interstitial flow velocity (v) or extremely complex and invisible microscale flow paths. To tackle this problem, various correlations have been proposed as functions of porosity for electrical conductivity, diffusivity, and hydraulic tortuosity. Moreover, tortuosity data were estimated from the experimental measurements of effective conductivity, acoustic wave propagation, and permeability. Depending on factors such as grain shape, arrangement, homogeneity, and path structure, tortuosity values were reported in the range of 1.7 through 4. Several new approaches based on Stokes flow analysis and tensorial tortuosity relations using a very small representative element volume have indicated that tortuosity is not only a function of porosity but also of pore geometry. However, these considerations are still not sufficiently accurate and universal for practical applications in actual ground formations with heterogeneous and complex pore structures having lengths ranging from hundreds of meters to several kilometers.

Moreover, the Kozeny constant (C_{K}) must be provided for the analyses of both permeability and permeability variations. However, determining this constant is a challenge. Literature review shows that the determination of the Kozeny constant is a widely studied problem. Kozeny constant was assigned a value of 4.8±0.3 by Carman for packed beds with uniform spheres, whereas Ergun proposed a value of 150 for the Blake-Kozeny constant. Xu and Yu derived an analytical expression for determining the permeability in a homogeneous porous medium with solid bars. Furthermore, the change in the Kozeny constant with porosity was investigated by Heijs and Lowe for a random array of spheres and a clay soil, by Gamrat et al. for two-dimensional cylinders in inline and staggered arrangements, by Karimian and Straatman for a metal foam structure, and by Liu and Hwang for fibrous porous media. Some researchers have proposed using a fixed value for the Kozeny constant, whereas others have established a relationship between this constant and porosity.

However, these methods are still not sufficiently accurate for practical application because the Kozeny constant is directly related to tortuosity. Again, various parameters, such as porosity, pore to throat size ratio, geometry, size, uniformity of grains, periodicity and isotropy of the porous structure are crucial in determining the tortuosity value.

As mentioned above, the Kozeny-Carman equation is one of the most promising models for permeability characterization. However, its applications are limited because of immeasurable variables such as the Kozeny constant (C_{K}) and hydraulic tortuosity (T).

Moreover, due to changes in forming stress and based on various porosity, the permeability (k) is given by the power-law function (φ) of porosity. For example, it can be expressed as k=αφ^{β}, where α and β are constants. The power-law functional correlation has been widely used in real applications. The usage of such relations in real application can be attributed to the fact that porosity is the only definable variable that can be used when analyzing the permeability variation.

However, in reality, these relations are confined to very special cases such as tested materials and cannot assure reliable results for actual complex formations. Permeability variation is not only the major concern in each field operation planning but also a major factor to ensure optimal facility design for the entire field lifetime. Therefore, more universal (accurate) correlations defined using determinable variables must be investigated and presented to overcome the aforementioned limitations caused by the undeterminable Kozeny constant and hydraulic tortuosity.

According to the present invention, the Kozeny-Carman equation for analytical permeability characterization only involving actually determinable variables may be provided. Here, effective tortuosity, an effective diameter and a superficial diameter of porous media are defined by applying the general viscous flow theory of non-circular conduits while replacing the immeasurable variables. Next, the Kozeny-Carman equation is revised by replacing the unmeasurable variables with effective variables. The correlations for major geometric variables with respect to the permeability variables are analyzed using the pore-scale simulation (PSS) method. The pore-scale simulation is based on two types of 20 porous medium models with porosity having a wide range of 13.4% to 47.4% and permeability having a range of 0.0073 Darcy to 18.3 Darcy. Finally, the correlations of the superficial diameter for permeability and porosity variations are presented, which are expected to be more generally utilized for permeability variation analyses.

Herein, the present invention provides several valuable functional aspects of the superficial diameter with porosity change, such as quadratic functional correlations, parallel shifts for each flow path, and less sensitive variations in low porosity ranges. Consequently, the present invention provides that permeability variations can be more precisely and generally estimated using the quadratic correlations of the superficial diameter with porosity changes.

Hereinafter, the effective tortuosity and a superficial effective diameter are described.

Kozeny equation is shown in Equation 3 (a) and Equation 3(b).

$$\begin{matrix}〈 Equation 3 〉 & \\ {υ}_{S} = \frac{u}{Φ} = ( - \frac{{D}_{h}^{2}}{μ \cdot 16 {C}_{K}} \frac{Δ P}{L} ) {( \frac{L}{{L}_{e}} )}^{2} = υ T & ( a )\end{matrix}$$

$$∴ T = \frac{L}{{L}_{e}} = \frac{u}{Φ υ}$$

$$or$$

$$u = Φυ T$$

$$∴ {k}_{k} = \frac{{D}_{h}^{2} \cdot Φ T}{16 {C}_{K}} \qquad ( b )$$

$$or$$

$${k}_{k} = \frac{{Φ}^{3}}{{S}_{S}^{2}} ( \frac{T}{{C}_{K}} )$$

$$∴ υ = - \frac{2 {D}_{h}^{2}}{μ \cdot {f}_{υ} {Re}_{υ}} \frac{Δ P}{L} \qquad ( c )$$

$$where$$

$${f}_{υ} = \frac{2 {D}_{h}}{{ρ}^{{υ}^{2}}} \frac{Δ P}{L} ,$$

$${Re}_{υ} = \frac{ρ υ {D}_{h}}{μ} \& ξ = \frac{{f}_{υ} {Re}_{υ}}{64} = \frac{{C}_{K}}{2}$$

$$∴ u = - \frac{2 {D}_{h}^{2}}{μ \cdot {f}_{u} {Re}_{u}} \frac{Δ P}{L} \qquad ( d )$$

$$or$$

$$k = \frac{2 {D}_{h}^{2} \cdot Φ T}{{f}_{υ} {Re}_{υ}} = \frac{Φ \cdot {D}_{h}^{2}}{32} \cdot ( \frac{T}{ξ} )$$

$$∵ {f}_{υ} {Re}_{υ} = {f}_{u} {Re}_{u} \cdot Φ T$$

In Equation 3, vₛ is a superficial flow velocity, u is a flow velocity, φ is porosity, Dₕ is a hydraulic diameter, μ is a fluid viscosity, C_{K} is a Kozeny constant, ΔP is pressure difference, L is a porous medium length, Lₑ is an actual pore flow length, v is an interstitial flow velocity, T is hydraulic tortuosity, k_{K} is Kozeny permeability, S_{S} is an specific surface area, fᵥ is a friction factor based on v, Reᵥ is a Reynolds number based on v, ρ is a fluid density, ξ is a friction ratio, fᵤ is a friction factor based on u, Reᵤ is a Reynolds number based on u, and k is permeability.

Equation 3 is established by substituting the tortuosity concept into the pressure gradient term of the modified Darcy's equation by Blake after assuming that the granular bed is equivalent to a group of parallel, similar channels. Here, the Kozeny constant is defined as the constant in general law of streamline motion through channels of uniform but non-circular cross sections. This corresponds to double the value of the friction ratio (ξ), which is used in viscous flow dynamics of normal pipes as the ratio of laminar friction constant (fᵥReᵥ) of non-circular cross section to that of circular cylinder (fᵥReᵥ=64); i.e. the friction ratio is defined as ξ=fᵥReᵥ/64 and is equal to half of the Kozeny constant, (C_{K}=2ξ). Accordingly, Kozeny's interstitial velocity relation in Equation 3 (a) can be transformed to a function of the laminar friction constant (fᵥReᵥ), as shown in Equation 3 (c). Then, Equation 3 (d) is obtained by consistently substituting Kozeny tortuosity definition in all interstitial velocity terms in Equation 3 (c), which is exactly identical to Darcy's equation in Equation 1.

Next, Carman suggested the Kozeny-Carman equation in Equation 2 additionally adopting the tortuosity definition into the superficial flow velocity term (vₛ) in Equation 3 (a) and then it has been accepted as the fundamental equation of porous flow analysis until now.

Nevertheless, there are still two undeterminable variables such as the Kozeny constant (C_{K}) and hydraulic tortuosity (T) in Equation 3. Moreover, it seems to be an improper substitution of Kozeny tortuosity because Carman substituted Kozeny hydraulic tortuosity definition in the superficial velocity term as (vₛ)=u/(φT). this provides the non-physical relation such as u=φvT² in Equation 2. The flow velocity is proportional to the flow path length, not length square, that is vₛ/v≠L²/Lₑ². Here, the additional increments of interstitial velocity (and pressure difference) may be considered by adjusting the Kozeny constant (friction ratio) instead of the tortuosity square term in the Kozeny-Carman equation. In addition, the definition of the Kozeny hydraulic tortuosity is the correlation between the flow velocity and interstitial velocity, that is v=u/(φT), and not the superficial velocity, that is vₛ/v=u/φ≠u/(φT).

Accordingly, in the present invention, the interstitial velocity term is redefined as a function of the actual flow path length (Lₑ) in Kozeny equation. Consequently, the effective diameter of porous medium (Dₑ) is defined as a function of tortuosity (T) and friction ratio (ξ), as Dₑ=Dₕ/(T ξ)^{0.5} in Equation 4(a). It is slightly different than that of normal conduits due to the variable pore path.

$$\begin{matrix}〈 Equation 4 〉 & \\ ∴ {D}_{e} = \frac{{D}_{h}}{{( T \cdot ξ )}^{0.5}} & ( a )\end{matrix}$$

$$∵ {υ}_{e} = - \frac{2 {D}_{e}^{2}}{μ \cdot {f}_{e} {Re}_{e}} \frac{Δ P}{{L}_{e}}$$

$$and$$

$$υ = - \frac{2 {D}_{h}^{2}}{μ \cdot {f}_{υ} {Re}_{υ}} \frac{Δ P}{L}$$

$$at$$

$${υ}_{e} ≡ υ$$

$$where$$

$${f}_{e} = \frac{2 {D}_{e}}{{ρ}^{{υ}^{2}}} \frac{Δ P}{{L}_{e}} ,$$

$${Re}_{υ} = \frac{ρ υ {D}_{e}}{μ}$$

$$and$$

$$ξ = \frac{{f}_{υ} {Re}_{υ}}{{f}_{e} {Re}_{e}} = \frac{{f}_{υ} {Re}_{υ}}{64}$$

$$∵ {f}_{υ} {Re}_{e} ≡ 64$$

$$∴ k = \frac{Φ \cdot {D}_{e}^{2} \cdot {T}^{2}}{32} \qquad ( b )$$

$$or$$

$$k = \frac{Φ \cdot \overline{{D}_{e}} {}^{2}}{32}$$

$$where$$

$$\overline{{D}_{e}} = {D}_{e} \cdot T = {D}_{h} \cdot {( \frac{T}{ξ} )}^{\frac{1}{2}}$$

$$∵ {υ}_{e} ≡ \frac{u}{Φ T}$$

In Equation 4, Dₑ is an effective diameter, Dₕ is a hydraulic diameter, T is hydraulic tortuosity, ξ is a friction ratio, vₑ is an effective interstitial flow velocity, μ is a fluid viscosity, fₑ is a friction factor based on vₑ, Reₑ is a Reynolds number based on vₑ, ΔP is pressure difference, Lₑ is an actual pore flow length, v is an interstitial flow velocity, fᵥ is a friction factor based on v, Reᵥ is a Reynolds number based on v, L is a porous medium length, ρ is a fluid density, k is permeability, φ is porosity, D̅ₑ̅ is a superficial effective diameter, and u is a flow velocity.

In a conventional viscous flow analysis, the effective diameter (Dₑ) is defined as the corrected hydraulic diameter of a non-circular pipe with the laminar friction constant (fₑReₑ=64) of an equivalent circular cylinder. The corrected Reynolds number (Reₑ) is also defined based on the effective diameter (Dₑ) and the internal flow velocity (v) for the given pressure difference (ΔP). Besides these general concepts, the tortuosity concept is adopted to Equation 4(a) to reasonably consider the extremely different flow aspects with simple changes in the flow directions owing to very different pore aspects and tortuous path structures in each direction. Subsequently, the permeability is redefined in Equation 4(b) based on the effective diameter, which is identical to Carman permeability definition in Equation 2(b) except that the hydraulic diameter is replaced by the effective diameter. Here, C_{K}=2 for cylinder.

Here, the superficial effective diameter (D̅ₑ̅) is additionally defined based on the superficial flow velocity (vₛ≠v) as another type of an effective diameter with a cylindrical friction constant and the same pressure difference but along the medium length (L). Nevertheless, the effective diameter remains a function of the unknown friction ratio (ξ) due to the undeterminable interstitial velocity. Hence, in the present invention, the effective diameter is redefined as a function of determinable hydraulic diameter (Dₕ).

Hereinafter, the effective tortuosity (Tₑ*) is defined, which is coupled with all determinable variables such as porosity and hydraulic diameter. Therefore, the “special hydraulic cylinder model” denoted by a superscripted “*”. The effective diameter is assumed identical to the hydraulic diameter under an identical pressure difference. That is, Dₑ=Dₕ at ΔP*=ΔP. Therefore, Lₑ*≠Lₑ and vₑ*≠vₑ, because fₑReₑ ≡64.

Herein, the interstitial velocity (vₑ*) of the special hydraulic cylinder model cannot be identical to the interstitial flow velocity (v) passing through the original porous medium, because the actual pore length of a porous medium cannot be a straight circular cylinder. Therefore, the flow path length (Lₑ*) of the special model may be different to the flow path length (Lₑ) of the original porous medium. That is, Tₑ*=L/Lₑ*=1/ξ*≠T.

Consequently, the effective tortuosity can be defined in Equation 5 on the basis of the hydraulic interstitial flow velocity (vₑ*≠vₑ) passing through the special hydraulic cylinder model under the identical pressure difference condition (ΔP*=ΔP).

$$\begin{matrix}〈 Equation 5 〉 & \\ {υ}_{e}^{*} = - \frac{2 {D}_{e}^{2}}{μ \cdot {f}_{e} {Re}_{e}} \frac{Δ P}{{L}_{e}^{*}} = - \frac{{D}_{h}^{2}}{32 μ} \frac{Δ P}{{L}_{e}^{*}} = \frac{u}{Φ {T}_{e}^{*}} & ( a )\end{matrix}$$

$$at$$

$${D}_{e} ≡ {D}_{h}$$

$$and$$

$${υ}_{s} = - \frac{\overline{{D}_{e}} {}^{2}}{32 μ} \frac{Δ P}{L} = \frac{u}{Φ}$$

$$∴ {\overline{D}}_{e} = {D}_{e} \cdot T = {D}_{h} \cdot {T}_{e}^{*}$$

$$∵ \frac{{υ}_{s}}{{υ}_{e}^{*}} = \frac{\overline{{D}_{e}} {}^{2}}{{D}_{h}^{2} \cdot {T}_{e}^{*}} = {T}_{e}^{*}$$

$$where$$

$${T}_{e}^{*} = \frac{L}{{L}_{e}^{*}} = \frac{u}{Φ {υ}_{e}^{*}} ,$$

$${L}_{e}^{*} \neq {L}_{e} ,$$

$${υ}_{e}^{*} \neq υ$$

$$∴ k = \frac{Φ \cdot {D}_{h}^{2} \cdot {T}_{e}^{* 2}}{32} \qquad ( b )$$

$$or$$

$$k = \frac{{Φ}^{3}}{2} {( \frac{{T}_{e}^{*}}{{S}_{S}} )}^{2}$$

$$where$$

$${T}_{e}^{*} = \frac{{D}_{e}}{{D}_{h}} \cdot T = {( \frac{T}{ξ} )}^{0.5} = \frac{1}{{ξ}^{*}}$$

In Equation 5, vₑ* is a hydraulic interstitial flow velocity of the special model, Dₑ is an effective diameter, μ is a fluid viscosity, fₑ is a friction factor based on vₑ*, Rₑ is a Reynolds number based on vₑ*, ΔP is pressure difference, Lₑ* is a flow path length of special model, Dₕ is a hydraulic diameter, vₛ is a superficial flow velocity, D̅ₑ̅ is a superficial effective diameter, u is a flow velocity, φ is porosity, T is hydraulic tortuosity, Tₑ* is effective tortuosity, k is permeability, S_{S} is an specific surface area, ξ is a friction ratio, and ξ* is a special friction ratio.

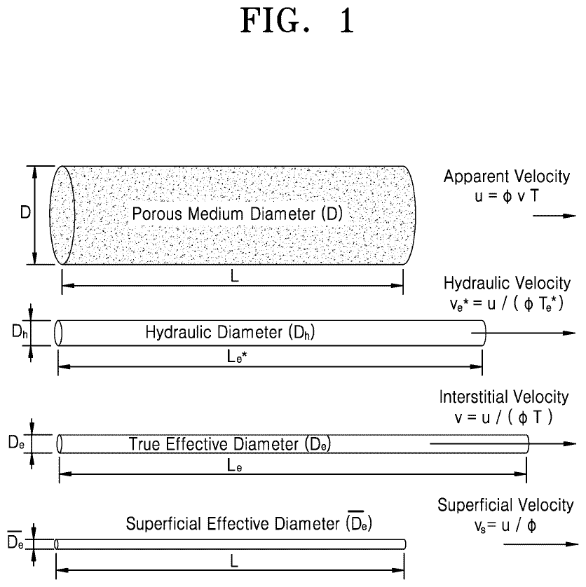

FIG. 1 is a schematic diagram showing hydraulic variables and effective variables based on a cylindrical medium in the method for predicting permeability according to geometrical change in a porous medium, according to an embodiment of the present invention.

Referring to FIG. 1, the diameter, length, and flow velocity of the pores in the porous medium are illustrated. For the porous medium, a length (L) and an apparent flow velocity (u) in the porous medium with respect to a diameter (D) are shown. A flow path length (Lₑ*) of the special cylinder model and a hydraulic flow velocity (vₑ*) of the special cylinder model with respect to a hydraulic diameter (Dₕ) are shown. An actual pore flow length (Lₑ) and an interstitial flow velocity (v) with respect to a true effective diameter (Dₑ) are shown. A porous medium length (L) and a superficial flow velocity (vₛ) with respect to a superficial (or apparent) effective diameter (D̅ₑ̅) are D shown.

Referring to FIG. 1, the key variables of each flow model are compared with those of the original porous medium. As shown in Equation 5(a), each of the flow velocities (vₑ*, vₛ) is correlated to their respective definitions for an identical apparent flow velocity (u) so that the correlations between hydraulic and effective variables could be obtained as those in Equation 5. In particular, the effective diameter (Dₑ) and superficial effective diameter (D̅ₑ̅) defined in Equation 4 are correlated with the hydraulic diameter using the effective tortuosity. Moreover, the permeability (k) in Equation 4(b) is redefined in Equation 5(b) as a function of the effective tortuosity (Tₑ*), exhibiting a similar form as that of Carman permeability (k_{C}) in Equation 2(b).

Comparing the permeability (k=Dₑ²φT²/32) in the in Equation 4(b) with the permeability (k_{C}=Dₕ²φT²/16C_{K}) in the in Equation 2(b), the only difference in Equation 4(b) is that the hydraulic diameter (Dₕ) is replaced with the effective diameter (Dₑ). Comparing the permeability (k_{C}=Dₕ²φTₑ*²/32) in the in Equation 5(b) with the permeability (k_{C}=Dₕ²φT²/16C_{K}) in the in Equation 2(b), the only difference in the Equation 5(b) is that the hydraulic tortuosity (T) is replaced with the effective tortuosity (Tₑ*).

Here, the special friction ratio (ξ*) is exactly proportional to the path length (Lₑ*) only in uniform hydraulic models. Here, the uniform hydraulic model has uniform and straight flow paths such as the special hydraulic cylinder model. That is, Tₑ*=1/ξ* and Tₑ*/ξ*=Tₑ*² at C_{K}=2. Therefore, the hydraulic tortuosity (T) in the Kozeny-Carman equation should be redefined using the effective tortuosity (Tₑ*), which is defined based on the special hydraulic cylinder model. This is because the friction ratio (ξ) of real material is not exactly proportional to the path length (Lₑ) of actually tortuous and irregular pore paths. That is, T≠1/ξ and Tₑ*²≠T².

This is proved in the next section using the pore-scale simulation analyses based on the two types of 20-series porous medium models. Consequently, it is verified that the Kozeny-Carman equation can be improved using either the effective tortuosity or diameter. Herein, the effective variables are deduced as the other definable key variables for more accurate and universal permeability variation analyses.

Hereinafter, permeability correlations of effective variables are described.

The permeability definitions in Equation 3 to Equation 5 have been revisited to examine the definable key variables correlated to the permeability variation caused by the pore aperture changes. Based on Equation 3, porosity (φ), hydraulic diameter (Dₕ), hydraulic tortuosity (T), and Kozeny constant (C_{K}=2ξ, that is friction constant ratio) can be distinguished to be the definable key variables of permeability. The effective diameter (Dₑ=Dₕ/(T ξ)^{0.5}) and the superficial diameter ((D̅ₑ̅=DₑT=Dₕ(T/ξ)^{1/2})) are defined in Equation 4. The effective tortuosity (Tₑ*) is introduced in Equation 5 by replacing the undeterminable variables of the hydraulic tortuosity and the Kozeny constant. Accordingly, the effective variables (Tₑ*, Dₑ, D̅ₑ̅) must also be examined along with the hydraulic variables (T and Dₕ) that are correlated with porosity(φ) and permeability(k).

Thereafter, pore-scale simulation analyses using two types of 20-series porous medium models are conducted to verify the key correlations and functional aspects of the definable key variables with respect to permeability variation.

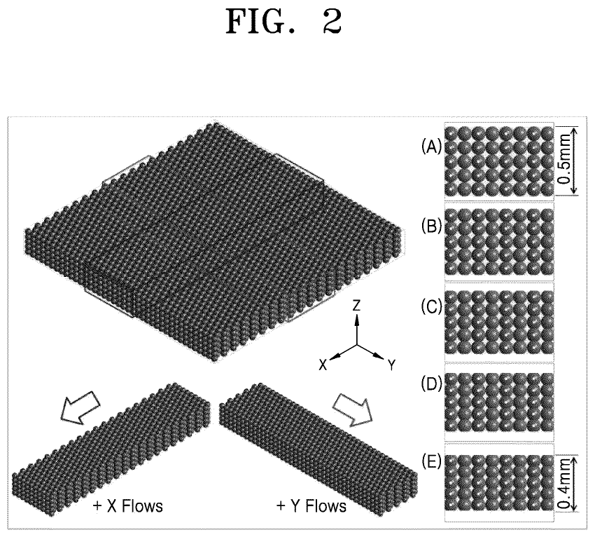

FIG. 2 shows a simple porous medium model for pore-scale simulation in the method for predicting permeability according to geometrical change in a porous medium, according to an embodiment of the present invention.

Referring to FIG. 2, the simple porous medium model for pore-scale simulation is shown. The simple porous medium model is constructed using microscale grid lattices and presents a multilayered three-dimensional (3D) shape having five layers in staggering arrays. The simple porous medium model has a shape in which grains (beads) of the same size are arranged, for example, 1975 spherical beads with a uniform diameter of 0.102 mm are arranged for each flow direction. The beads (i.e., grains) can have a radius in the range of 45 μm to 55 μm. The original diameter of the beads is excluding the portion cut by the plate or the portion overlapped by adjacent beads. That is, the beads can be represented by being cut by the plates and the overlapping of adjacent beads. They are positioned between the two plates, mimicking the staggered distribution of supports within the crack.

The geometric structure of a “base model” of the simple porous medium model is shown in the top left portion. The geometric comparison of the aperture reduction in the X-Z plane for the five models is shown in the right portion. (A) is a “thickest model” having an initial crack height (h) of 0.5 mm, (B) is a “thick model” having a crack height of 0.475 mm, (C) is a “base model” having a crack height of 0.45 mm, (D) is a “thin model” having a crack height of 0.425 mm, and (E) is a “thinnest model” having a crack height of 0.4 mm. Each of the models has five multilayers. In each model, the beads are assumed to simply and homogeneously shrink into adjacent beads or walls as the crack height changes. The simple porous medium model can have the crack height in the range of 0.4 mm to 0.5 mm and the porosity in the range of 36% to 47.5%.

Two types of the simple porous medium model for each flow direction is shown in the lower left portion. In the simple porous medium model shown in the upper left portion, the blue area is the X-direction flow model in the blue direction, and the red area is the Y-direction flow model in the red direction. Here, two perpendicular flow directions (X and Y) are introduced to the simple porous medium model, respectively, to evaluate various flow shapes related to the directional pore path due to the influence of hydraulic tortuosity.

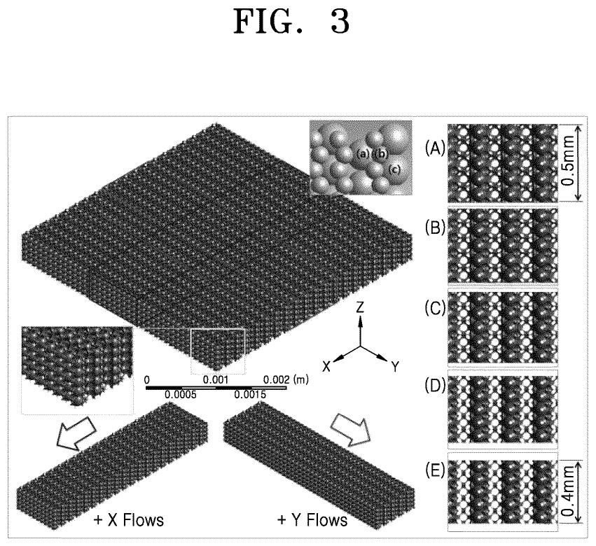

FIG. 3 shows a complex porous medium model for pore-scale simulation in the method for predicting permeability according to geometrical change in a porous medium, according to an embodiment of the present invention.

Referring to FIG. 3, the complex porous medium model for pore-scale simulation is illustrated. The complex porous medium model is constructed using fine grid lattices, and a multilayered three-dimensional (3D) shape having five layers in staggered arrangements is shown. The complex porous medium model has a shape in which grains of different sizes are arranged, and the grains of different sizes can be arranged in a staggered manner. The grains can have a radius in the range of 30 μm to 55 μm.

For example, the complex porous medium model can be configured to include beads of three different sizes, thereby representing more dense and realistic models. This complex porous medium model is set up to extensively analyze cases that exhibit a wide range of porosity from 13.4% to 47.4% and permeability from 0.0073 Darcy to 18.3 Darcy.

The geometric structure of a “base model” of the complex porous medium model is shown in the top left portion. The three different sizes of the 28,160 microbeads are shown without the others. The geometric comparison of the aperture reduction in the X-Z plane for the five models is shown in the right portion. (A) is a “thickest model” having an initial crack height (h) of 0.5 mm, (B) is a “thick model” having a crack height of 0.475 mm, (C) is a “base model” having a crack height of 0.45 mm, (D) is a “thin model” having a crack height of 0.425 mm, and (E) is a “thinnest model” having a crack height of 0.4 mm. Each of the models has five multilayers. The complex porous medium model can have the crack height in the range of 0.4 mm to 0.5 mm, and the porosity in the range of 13.3% to 22.6%.

An enlarged view to better illustrate the complex pore structure is shown in the left middle portion. Three bead sizes with staggered arrangements are shown in the upper left portion, with (a) beads having 51 μm radius, (b) beads having 30 μm radius, and (c) beads having 55 μm radius.

Two types of complex porous medium models for each flow direction are shown in the lower left portion. In the complex porous medium model shown in the upper left portion, the blue area is the X-direction flow model in the blue direction, and the red area is the Y-direction flow model in the red direction. Here, two perpendicular flow directions (X and Y) are introduced into the complex porous medium model, respectively, to evaluate various flow shapes related to the directional pore paths due to the influence of hydraulic tortuosity.

Referring to FIGS. 2 and 3, since the simple porous medium model and the complex porous medium model have five types each for the X-direction and the Y-direction, a total of 20 cases of pore-scale simulation models can be constructed. The simple porous medium model and the complex porous medium model combine five pore arrangements and two flow directions (X and Y), and can be classified into 10 types each.

Hereinafter, more detailed geometrical features, numerical settings, and evaluation of the simple porous medium model are described.

In the simple porous medium model, an original multilayer 3D porous medium is assumed as a simple structural shape. A group of plates has the dimensions of 4-mm-length×4-mm-width×0.5-mm-height and is filled with 5 layers of identical spherical beads. From the original model, the flow direction is divided into X-direction and Y-direction, and two types are set.

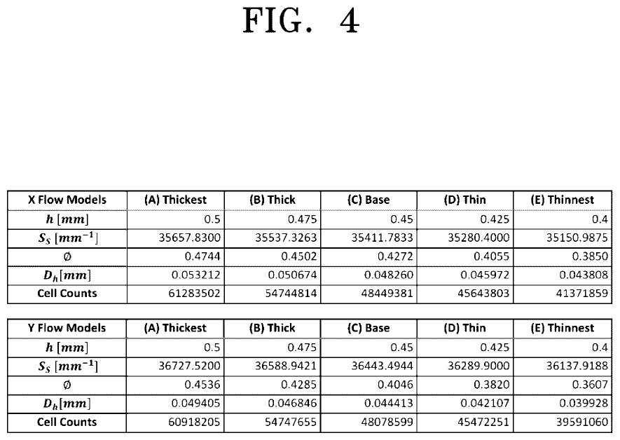

FIG. 4 is a table showing key geometric shape information for performing the pore-scale simulation of the simple porous medium model in the method for predicting permeability according to geometrical change in a porous medium, according to an embodiment of the present invention.

Referring to FIG. 4, crack height (h), specific surface area (S_{S}), porosity (φ), hydraulic diameter (Dₕ), and cell count of the simple porous medium model are shown.

The “thickest model” in (A) is defined in the original model to have geometric dimensions of 4-mm-length×1-mm-width×0.5-mm-height for each direction. Similarly, the “thick model” in (B) has a height of 0.475 mm, and the “base model” in (C) has a height of 0.45 mm. Since the hole shrinkage occurs due to stress variation in the vertical direction, it is assumed that beads in each medium is simply and uniformly inserted into the adjacent bead and wall. The “thin model” in (D) has a height of 0.425 mm, and the “thinnest model” in (E) has a height of 0.4 mm. The final fine grid size of the unstructured tetrahedral grid systems of each model is verified using different grid resolutions.

The fluid is assumed to be pure liquid water, with a density of 998.2 kg/m³ and a viscosity of 0.001003 kg/ms. The solid walls or surfaces of all models are assumed to be completely smooth and isothermal. That is, the grains can have smooth surfaces and isothermal.

The apparent velocity (u) is 0.1 mm/s, and is set perpendicular to the two vertical injection ports in the Y-Z plane and the X-Z plane, and aligned with respect to the respective flow directions of X and Y as shown in FIG. 2. Here, in order to confirm that the 0.1 mm/s condition satisfies the Darcy flow rule with other conditions, a 0.01 mm/s condition is additionally implemented.

In summary, pore-scale simulations are performed for a total of 20 simple porous medium models under steady-state flow conditions using commercial Ansys-fluent software of Ansys. The 20 cases consist of five different bead arrangements, two different flow velocities, and two different directions. The geometric and flow conditions other than those mentioned above are the same in all cases. The basic convergence criterion is set to a residual less than 10⁻⁸ in all equations. The second-order upwind scheme and the SIMPLE method are applied to spatial discretization and pressure-velocity coupling, respectively.

Here, the applied fine grid system, numerical settings, and flow conditions are verified through pore-scale simulations performed first using the “plate model”. The plate model is composed of horizontally parallel plates with the dimensions of 4-mm-length×1-mm-width. It is identical to the simple porous medium model of the original type, but the height is 10 times smaller in order to form the Reynolds numbers of the plate model for the targeted pore-scale simulations in the same order. That is, the height is 0.05 mm and the aspect ratio is 0.0125.

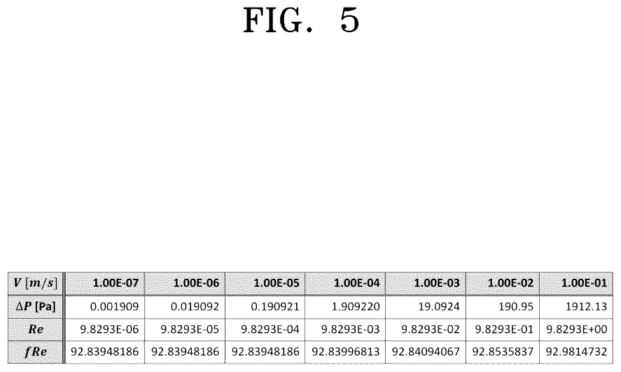

FIG. 5 is a table showing key pore-scale simulation results of a flat plate model in the method for predicting permeability according to geometrical change in a porous medium, according to an embodiment of the present invention.

Referring to FIG. 5, flow velocity (v), pressure difference (ΔP), Reynolds number (Re), and friction constant (fRe) are shown. The numerical validity of the pore-scale simulation results of the simple porous medium model is examined by comparing the pressure difference (pressure drop) derived from the Hagen-Poiseuille equation with the pressure difference of the pore-scale simulation results under laminar flow conditions. According to the linear regression analysis of the friction constant (fRe) according to the changes in the aspect ratio of the rectangular duct, when the friction constant (fRe) value of the flat plate model is about 92.4, the difference by comparison is about 0.5%.

Hereinafter, the more detailed geometrical shapes, numerical settings, and evaluation of the complex porous medium model will be described.

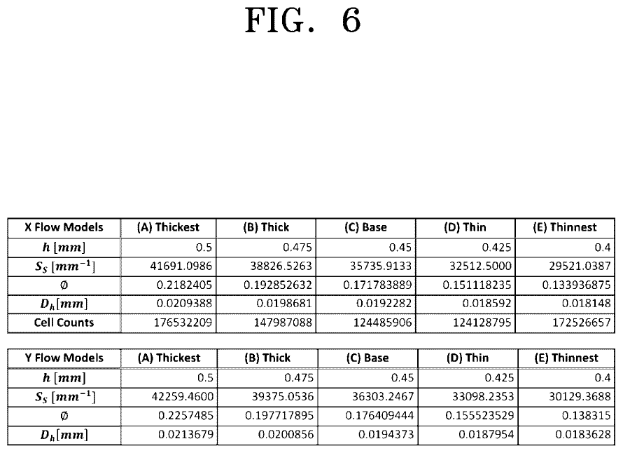

FIG. 6 is a table showing key geometric shape information for performing the pore-scale simulation of the complex porous medium model in the method for predicting permeability according to geometrical change in a porous medium, according to an embodiment of the present invention.

Referring to FIG. 6, crack height (h), specific surface area (S_{S}), porosity (φ), hydraulic diameter (Dₕ), and cell count of the complex porous medium model are shown.

Referring to FIG. 3, in the complex porous medium model, the parallel plates are filled with five layers of three different sized spherical beads in staggered arrangements for five different pores. Here, similar to the simple porous medium model, two directional flow conditions (X and Y) are defined.

For the “Base” model, after examining the Darcy flow rule by combining the velocity condition of 0.001 mm/s for each flow direction, the input velocity is set to 0.01 mm/s. The basic convergence criterion is set to a residual less than 10⁻⁷ in all mathematical equations. Other flow conditions and settings of the pore-scale simulation for the complex porous medium model is set the same as those for the simple porous medium model. The grid resolution, such as minimum surface area, maximum surface area and grid volume, is reduced and therefore changed for several models.

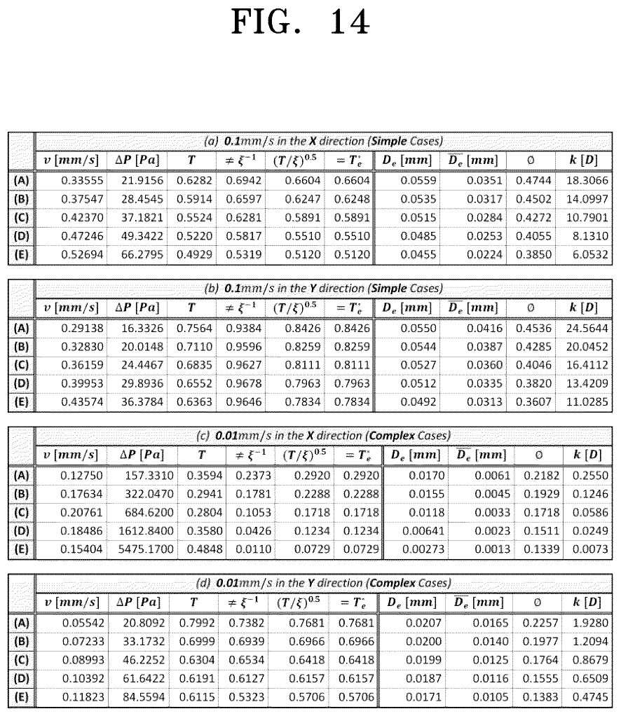

Referring to FIG. 14 below, initial variables such as the average interstitial flow velocity (v) and pressure difference (ΔP) are directly obtained from the pore-scale simulation results, and the simulation based on 200,000 uniformly distributed streamline seeds for each pore-scale simulation is performed, thereby deriving the streamline distribution of the fluid.

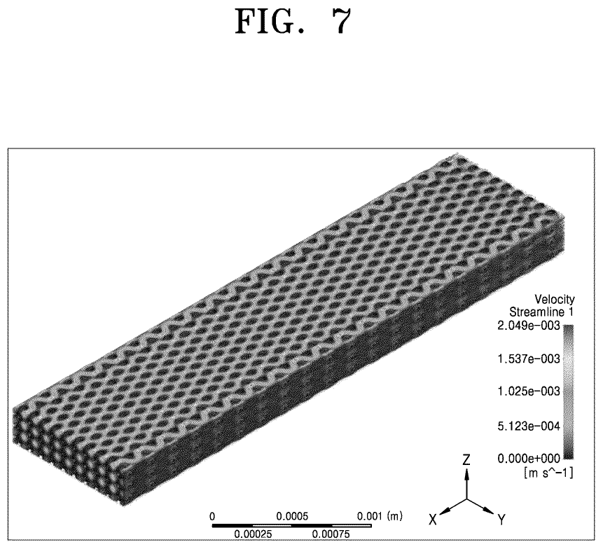

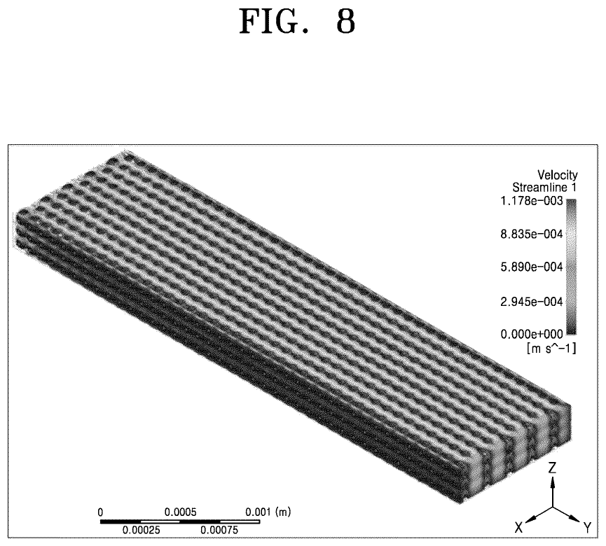

FIGS. 7 and 8 show streamline distributions derived from the pore-scale simulation results for the simple porous medium model in the method for predicting permeability according to geometrical change in a porous medium, according to an embodiment of the present invention.

Referring to FIG. 7, as a result of the pore-scale simulation for the simple porous medium model, the streamline distribution according to the flow condition in the X-direction at the apparent flow velocity (u) of 0.1 mm/s for the “Base Model” is shown. The streamline distribution is shown by cutting between the third and fourth layers from the bottom.

Referring to FIG. 8, as a result of the pore-scale simulation for the simple porous medium model, the streamline distribution according to the flow condition in the Y-direction at the apparent flow velocity (u) of 0.1 mm/s for the “Base Model” is shown. The streamline distribution is shown by cutting between the third and fourth layers from the bottom.

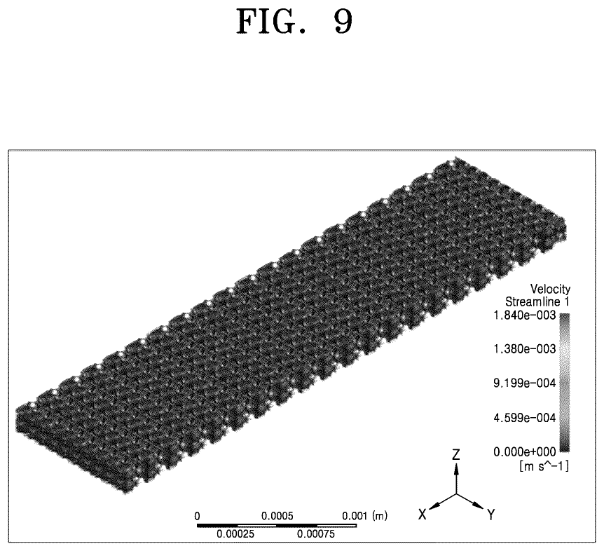

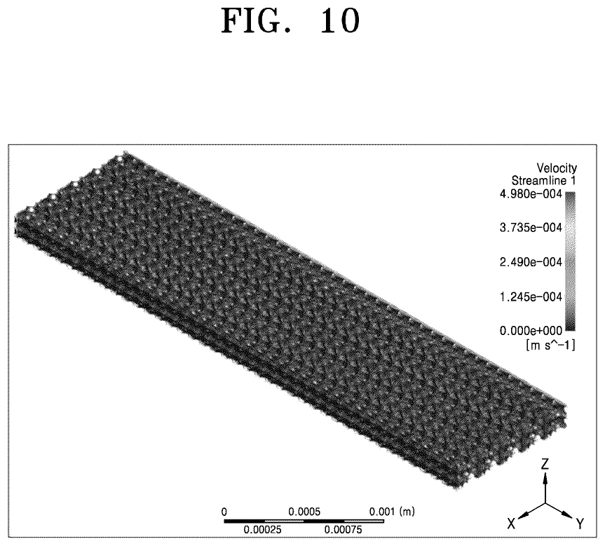

FIGS. 9 and 10 show streamline distributions derived from the pore-scale simulation results for the complex porous medium model in the method for predicting permeability according to geometrical change in a porous medium, according to an embodiment of the present invention.

Referring to FIG. 9, as a result of the pore-scale simulation for the complex porous medium model, the streamline distribution according to the flow condition in the X-direction at the apparent flow velocity (u) of 0.01 mm/s for the “Base Model” is shown. The streamline distribution is shown by cutting between the second and third layers from the bottom.

Referring to FIG. 10, as a result of the pore-scale simulation for the complex porous medium model, the streamline distribution according to the flow condition in the Y-direction at the apparent flow velocity (u) of 0.01 mm/s for the “Base Model” is shown. The streamline distribution is shown by cutting between the second and third layers from the bottom.

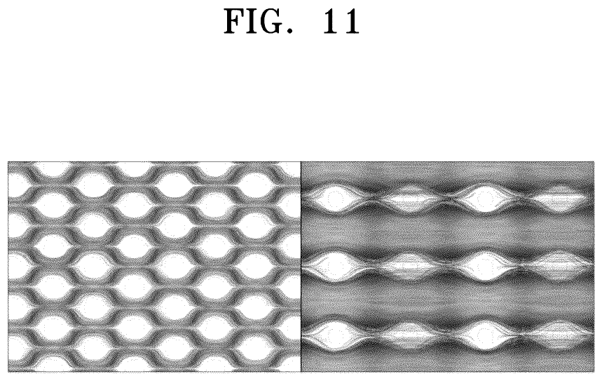

FIGS. 11 through 13 show enlarged streamline distributions derived from the pore-scale simulation results for the porous medium model in the method for predicting permeability according to geometrical change in a porous medium, according to an embodiment of the present invention.

In FIGS. 11 through 13, the left side shows the streamline distribution for the central part of the X-Y plane, and the right side shows the streamline distribution for the central part of the X-Z plane.

Referring to FIG. 11, as pore-scale simulation results for the simple porous medium model, the streamline distribution according to the flow condition in the X-direction at the apparent flow velocity (u) of 0.1 mm/s for the “Base Model” is shown in an enlarged manner.

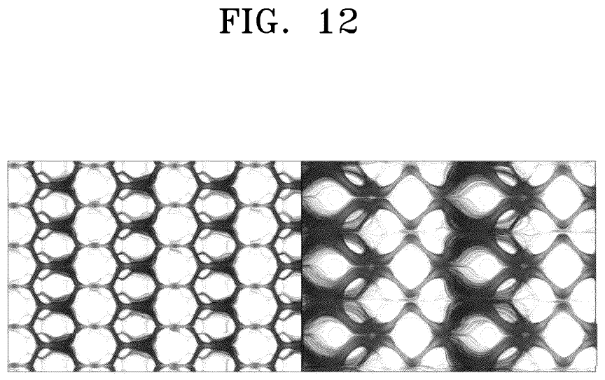

Referring to FIG. 12, as pore-scale simulation results for the complex porous medium model, the streamline distribution according to the flow condition in the X-direction at the apparent flow velocity (u) of 0.01 mm/s for the “Base Model” is shown in an enlarged manner.

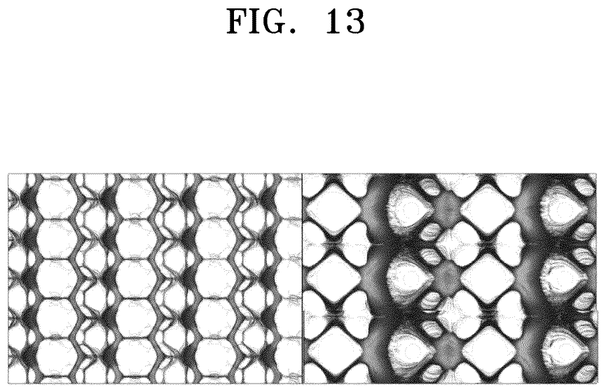

Referring to FIG. 13, as pore-scale simulation results for the simple porous medium model, the streamline distribution according to the flow condition in the Y-direction at the apparent flow velocity (u) of 0.01 mm/s for the “Base Model” is shown in an enlarged manner.

Referring to FIGS. 7 through 13, compared to the pore-scale simulation results of the simple porous medium model, the pore-scale simulation results of the complex porous medium model show that more friction occurs and thus the flow has a complex shape. This result is analyzed to be because the flow path in the complex porous medium model is configured to be narrow and twisted repeatedly.

FIG. 14 is a table showing variables derived from the pore-scale simulation results in the method for predicting permeability according to geometrical change in a porous medium, according to an embodiment of the present invention.

Referring to FIG. 14, for the simple porous medium model above (simple cases), the variables for the X-direction and Y-direction for the apparent velocity (u) of 0.1 mm/s are shown. For the complex porous medium model above (complex cases), the variables for the X-direction and Y-direction for the apparent velocity (u) of 0.1 mm/s are shown. The pore-scale simulation results are totally 20.

From the pore-scale simulation results, the average interstitial flow velocity (v) and pressure difference (ΔP) are obtained. Here, the average interstitial flow velocity (v) can be obtained from the length averaged streamline velocity from the pore-scale simulation results.

Then, using Equation 3, the derived variables such as hydraulic tortuosity (T), friction ratio (ξ), and permeability (k) are calculated. Then, using the Equation 4 and Equation 5, effective diameter (Dₑ), superficial effective diameter (D̅ₑ̅), and effective tortuosity (Tₑ*) are calculated.

The results of the analysis show that the hydraulic tortuosity (T) is not exactly proportional to the reciprocal of the friction ratio (1/ξ) in actual, irregular, and tortuous pore paths. That is, T≠1/ξ‥1/ξ* and Tₑ*²≠T². Therefore, the Equation 4(b) and Equation 5(b) revised using either effective diameter or tortuosity are the reasonably improved definitions of the Kozeny-Carman equation.

The permeability variation correlations for four types of each 5-series pore-scale simulation analysis are plotted with the individual coefficient of determination (R-square value, R²) as the power-law functions for each geometric variable such as porosity, hydraulic diameter, and hydraulic tortuosity.

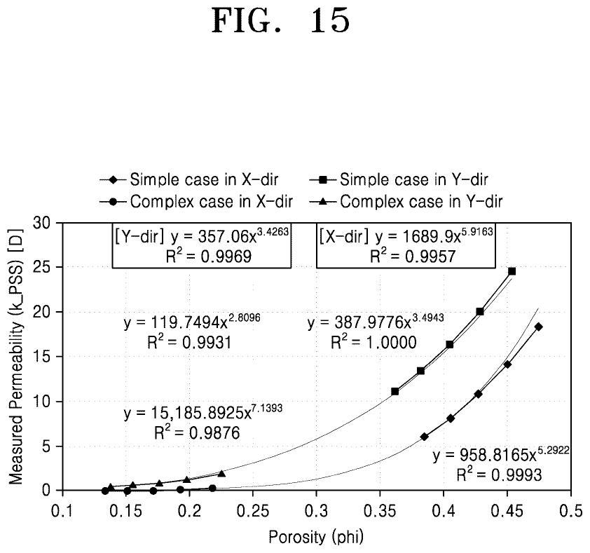

FIGS. 15 through 27 are graphs showing correlations of variables obtained from the pore-scale simulations in the method for predicting permeability according to geometrical change in a porous medium, according to an embodiment of the present invention.

Referring to FIG. 15, the correlation between the porosity and the measured permeability is shown.

The power-law functional aspects of porosity and permeability can be well observed. Here, the variation trends can be integrated into a single function of porosity for each directional flow case. Therefore, permeability variations can be defined as the power-law functions of porosity for the respective flow paths.

Specifically, the simple porous medium model for the X-direction (simple case in X-dir) shows a power-law functional correlation of y=958.8165x^{5.2922}. The complex porous medium model for the X-direction (complex case in X-dir) shows a power-law functional correlation of y=15185.8925x^{7.1393}. In addition, integrating the results of the simple porous medium model for the X-direction and the results of the complex porous medium model for the X-direction, a power-law functional correlation is y=1689.9x^{5.9163.}

The simple porous medium model for the Y-direction (simple case in Y-dir) shows a power-law functional correlation of y=387.9776x^{5.9163}. The complex porous medium model for the Y-direction (complex case in Y-dir) shows a power-law functional correlation of y=119.7497x^{2.8096}. In addition, integrating the results of the simple porous medium model for the Y-direction and the results of the complex porous medium model for the Y-direction, a power-law functional correlation is y=357.06x^{3.4263}. Here, in the power-law functional correlations, x represents the porosity and y represents the permeability.

However, since in the complex porous medium model, the R² values appear relatively low, the power-law functional correlation is very sensitive to porosity changes in the region with low porosity and tortuosity for more realistic materials. Furthermore, no general aspect of the permeability variation with porosity can be observed.

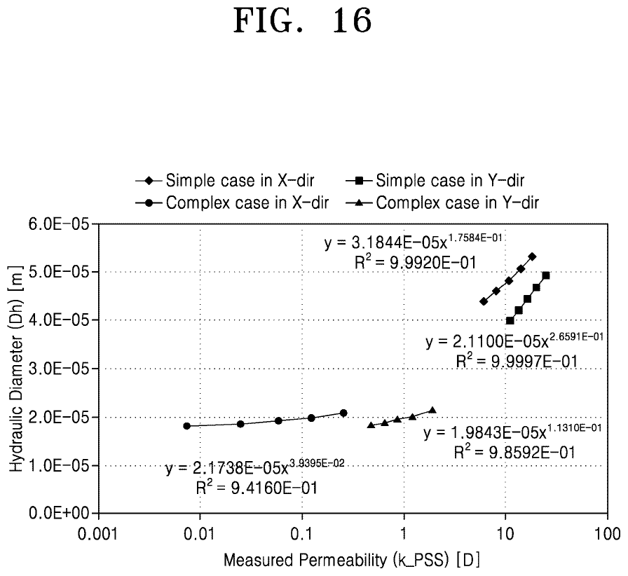

Referring to FIG. 16, the correlation between the measured permeability and the hydraulic diameter is shown. Comparing the results in FIG. 15, the R² values decreases, and no general aspect of the permeability variation with hydraulic diameter can be observed.

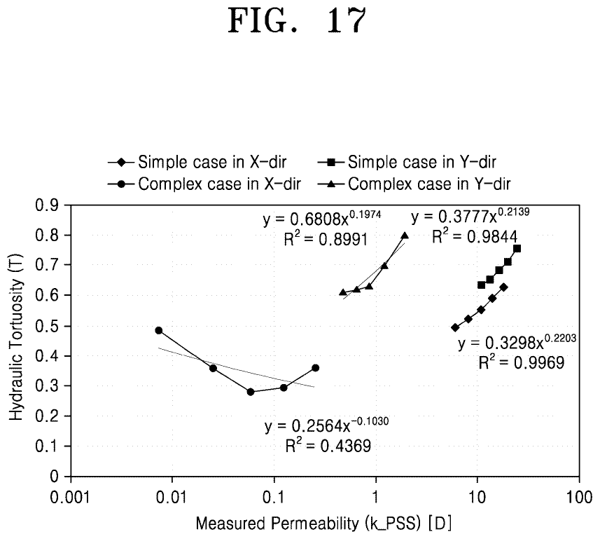

Referring to FIG. 17, the correlation between the measured permeability and the hydraulic tortuosity is shown. In the correlation between the permeability and the hydraulic tortuosity, it can be seen that the decrease in R² values is more complex and significant. In particular, in the area having low porosity and hydraulic tortuosity corresponding to more realistic materials, i.e., in the complex porous medium model, the decrease in R² values is noticeable. Therefore, it is analyzed that hydraulic variables such as hydraulic diameter or hydraulic tortuosity are not uniquely related to permeability changes and no useful correlations can be obtained.

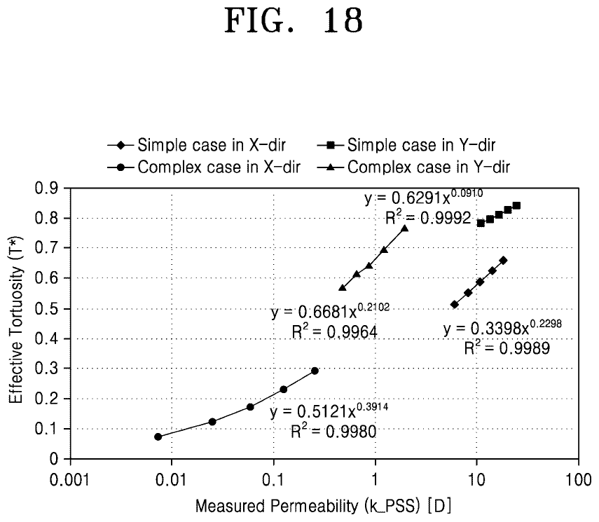

Next, the individual power-law functional correlations of effective tortuosity (Tₑ*) and effective diameter (Dₑ) are shown in FIGS. 18 to 21.

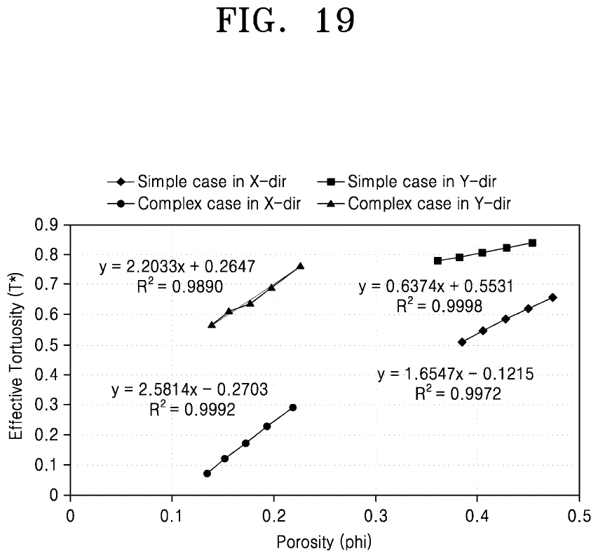

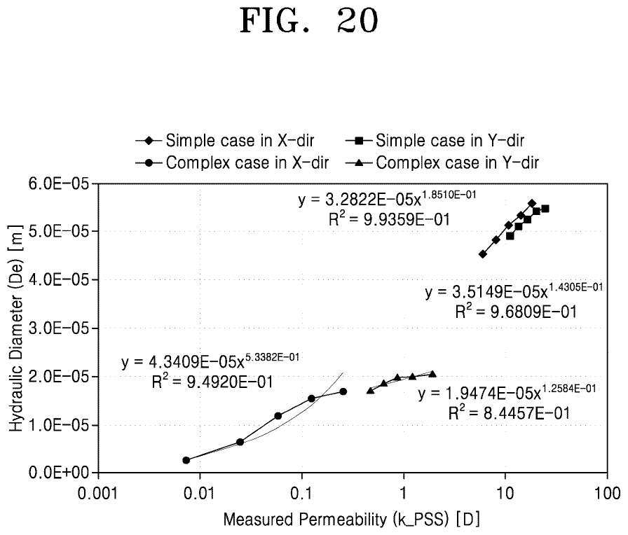

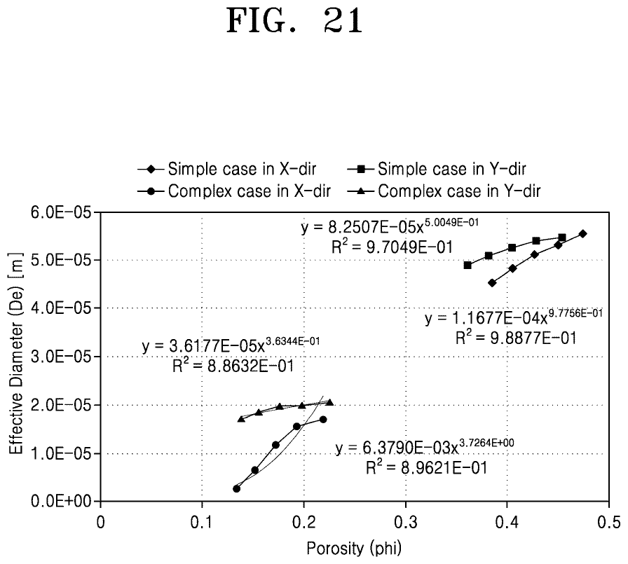

Referring to FIG. 18, the correlation between the measured permeability and the effective tortuosity is shown. Referring to FIG. 19, the correlation between the porosity and the effective tortuosity is shown. Referring to FIG. 20, the correlation between the measured the permeability and the effective diameter is shown. Referring to FIG. 21, the correlation between the porosity and the effective diameter is shown.

Referring to FIGS. 18 through 21, no universal correlations are found for each flow direction. However, each R² value of the respective power-law functional correlations based on the effective tortuosity in the denser and more tortuous cases is higher than that obtained based on the porosity correlations. Moreover, referring to FIG. 18, the linear variation trends of the effective tortuosity as a function of porosity exhibit high R² values. These trends imply that permeability variation could be more accurately defined as the power-law function of effective tortuosity (i.e., k=α(Tₑ*)^{β}) or coupled with the linear porosity relation (i.e., k=α(γφ+δ)^{β}). Otherwise, referring to FIGS. 20 and 21, the effective diameter (Dₑ) does not show any specific trend or correlation.

From these results, it may be difficult to derive a valid correlation between the hydraulic diameter, hydraulic tortuosity, effective tortuosity, and effective diameter (Dₑ) for the entire range of permeability. In addition, it may be difficult to derive valid correlations between the effective tortuosity, the effective diameter (Dₑ), and the porosity for the entire range.

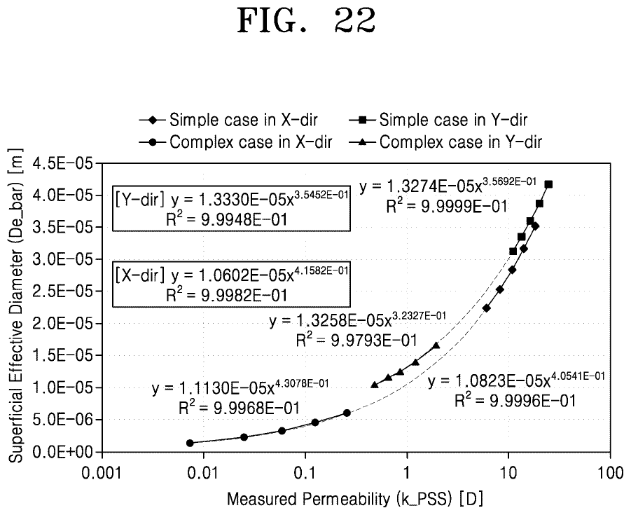

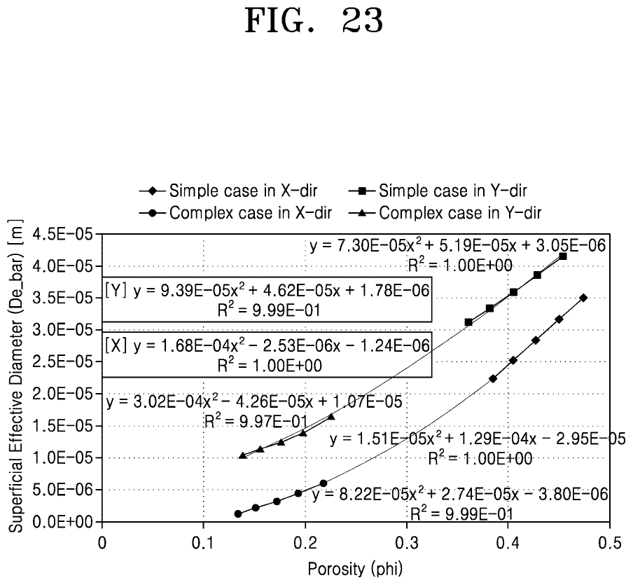

Next, the correlations of the superficial effective diameter (D̅ₑ̅) with changes in permeability and porosity are analyzed, and several interesting aspects are discovered, as shown in FIGS. 22 and 23.

Referring to FIG. 22, the correlation between the measured permeability and the superficial effective diameter is shown. For both the simple porous medium model and the complex porous medium model, it can be seen that the correlation between the permeability and the superficial effective diameter in each flow direction exhibits the same power-law regression curves with very high R² values.

Specifically, the simple porous medium model for the X-direction (simple case in X-dir) shows a power-law functional correlation of y=1.0823E-05x^{4.0541E-01}. The complex porous medium model for the X-direction (complex case in X-dir) shows a power-law functional correlation of y=1.1130E-05x^{4.3078E-01}. In addition, integrating the results of the simple porous medium model for the X-direction and the results of the complex porous medium model for the X-direction, a power-law functional correlation is y=1.0602E-05x^{4.1582E-01}.

The simple porous medium model for the Y-direction (simple case in Y-dir) shows a power-law functional correlation of y=1.3274E-05x^{3.5692E-01}. The complex porous medium model for the Y-direction (complex case in Y-dir) shows a power-law functional correlation of y=1.3258E-05x^{3.2327E-01}. In addition, integrating the results of the simple porous medium model for the Y-direction and the results of the complex porous medium model for the Y-direction, a power-law functional correlation is y=1.3330E-05x^{3.5452E-01}. Here, in the power-law functional correlations, x represents the permeability and y represents the superficial effective diameter.

The regression curves for each flow direction are very close to each other and have very similar and parallel slopes. Therefore, it can be seen that the change in permeability has a more general correlation with the superficial effective diameter, as the slopes are nearly identical for very different porous medium models.

Referring to FIG. 23, the correlation between the porosity and the superficial effective diameter is shown. For the simple porous medium model and the complex porous medium model, it can be seen that the correlation between the porosity and the superficial effective diameter in each flow direction shows the same quadratic regression curve with very high R² values.

Specifically, the simple porous medium model for the X-direction (simple case in X-dir) shows a quadratic functional correlation of y=1.15E-05x²+1.29E-04x-2.95E-05. The complex porous medium model for the X-direction (complex case in X-dir) shows a quadratic functional correlation of y=8.22E-05x²+2.74E-05x-3.80E-06. In addition, integrating the results of the simple porous medium model for the X-direction and the results of the complex porous medium model for the X-direction, a quadratic functional correlation is y=1.68E-04x²+2.53E-06x-1.24E-06.

The simple porous medium model for the Y-direction (simple case in Y-dir) shows a quadratic functional correlation of y=7.30E-05x²+5.19E-05x-3.05E-06. The complex porous medium model for the Y-direction (complex case in Y-dir) shows a quadratic functional correlation of y=3.02E-04x²-4.26E-05x+1.07E-05. In addition, integrating the results of the simple porous medium model for the Y-direction and the results of the complex porous medium model for the Y-direction, a quadratic functional correlation is y=9.39E-05x²+4.62E-05x+1.78E-06. Here, in the quadratic functional correlations, x represents the porosity and y represents the superficial effective diameter.

It can be seen that the superficial effective diameter is a quadratic function of the porosity, with very high R² values. In addition, the shapes of the two regression curves integrated for each flow direction are very similar and almost parallel.

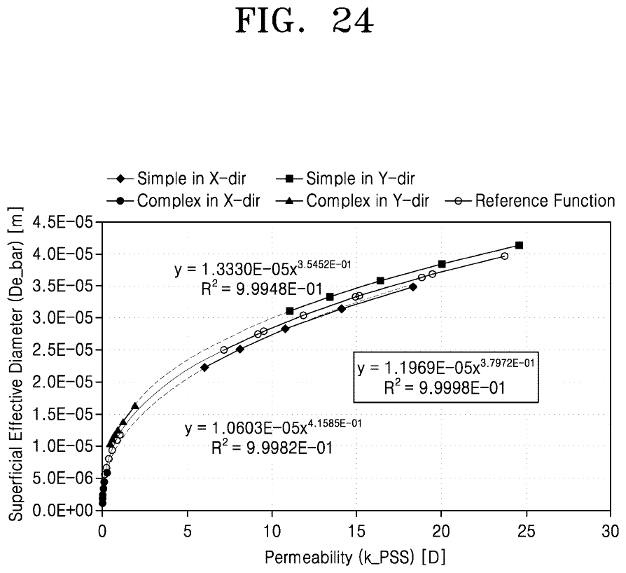

Referring to FIG. 24, the correlation between the permeability calculated based on the superficial diameter and the superficial effective diameter is shown.

Referring to FIG. 24, as described above in FIG. 22, the power-law functional correlation of y=1.0602E-05x^{4.1582E-01} for the X-direction is derived from the integration of the results of the simple porous medium model and the results of the complex porous medium model, and the power-law functional correlation of y=1.3330E-05x^{3.5452E-01} for the Y-direction is derived from the integration of the results of the simple porous medium model and the results of the complex porous medium model.

By interpolating the data for the X-direction and the data for the Y-direction, the correlation of the reference function between the permeability and the superficial effective diameter can be derived. The reference function has a power-law functional correlation of y=1.1969E-05x^{3.7972E-01}. Accordingly, the varying permeability can be approximated using the reference (mean) function if a reliable superficial diameter is provided.

For example, the future permeability of the well, denoted as 24 Darcy, can be predicted from the given superficial diameter. However, in reality, the future superficial diameter cannot be determined because the Kozeny constant and hydraulic tortuosity are unpredictable, although the relations of the superficial diameter in Equation 5(a) D̅ₑ̅=Dₑ T=Dₕ Tₑ*) are expected to aid the determination.

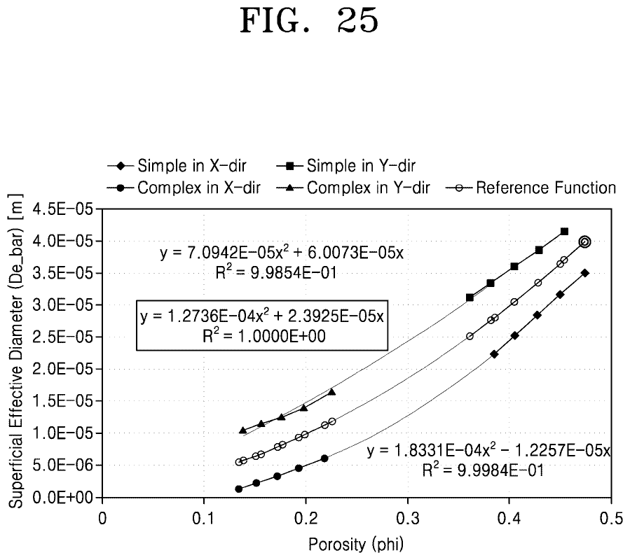

Referring to FIG. 25, the correlation between the porosity and the superficial effective diameter is shown.

Referring to FIG. 25, as described above in FIG. 23, the quadratic functional correlation of y=1.8331E-04x²-1.2257E-05x for the X-direction is derived from the integration of the results of the simple porous medium model and the results of the complex porous medium model, and the quadratic functional correlation of y=7.0942E-05x²+6.0073E-05x for the Y-direction is derived from the integration of the results of the simple porous medium model and the results of the complex porous medium model. Here, since in a real situation since the permeability is 0 when the porosity is 0, the quadratic functions for the X-direction and Y-direction are expressed as quadratic functions with an intercept of 0.

By interpolating the data for the X-direction and the data for the Y-direction, the correlation of the reference function between the porosity and the superficial effective diameter can be derived. The reference function has a quadratic functional correlation of y=1.2736E-04x²+2.3925E-05x.

From the correlations between the porosity and the superficial effective diameter in FIG. 25, it is possible to determine future superficial diameters for a given porosity, and to further provide the possibility to determine the permeability. The parallel quadratic functional aspects of the superficial diameter for porosity variation can be used to present its mean variation curve. Therefore, any required permeability for future geometric changes can be estimated using the superficial diameter correlation for porosity variation. Herein, the quadratic functional aspect of the superficial diameter can provide more accurate correlations than the power-law functional correlation of permeability in low porosity ranges (more realistic cases). The variation slopes in low porosity regions are less sensitive and more distinguishable than those of power-law functional curves. Moreover, the parallel shift aspect is beneficial for determining the permeability and its variation correlations of family medium (and flow direction changes in the same formation). The superficial diameter correlations can be more precisely and easily obtained than power-law functional permeability-porosity correlations.

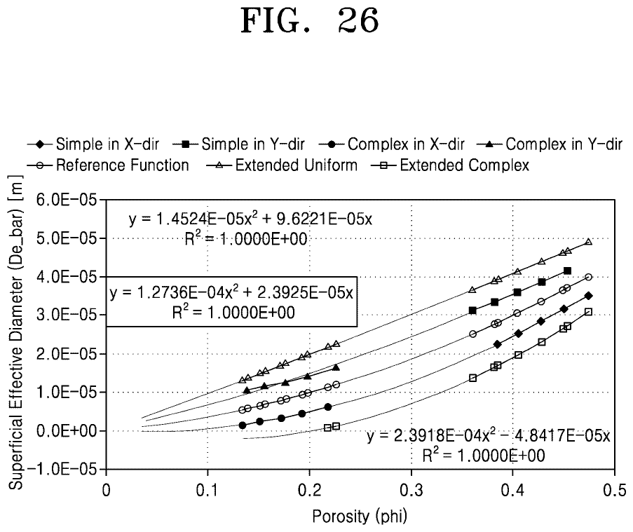

Referring to FIG. 26, extended correlations between the porosity and the superficial effective diameter are shown.

Referring to FIG. 26, it is shown that the correlation between the porosity and the superficial effective diameter shown in FIG. 25 can be easily extended, either interpolated or extrapolated, to other families of materials or to other wells in the same formation, i.e., when the flow path changes.

In actual fields, porosity and permeability of a reference well can be obtained in advance via core tests or production logging tests under more than two formation stress conditions. Then, the reference quadratic correlation of the superficial effective diameter with porosity change can be generated by calculating each superficial effective diameter using Equation 4(b) based on the measured data. The reference function has a quadratic function correlation of y=1.2736E-04x²+2.3925E-05x.

Thus, future permeability variations in an identical formation can be predicted using the reference function curve. For other wells of the same or family formations, the reference function curve can be interpolated or extrapolated to obtain various quadratic function curves. Here, using Equation 4(b), each initial value of a superficial diameter based on the respective initial porosity and permeability value of each target well can be calculated.

The uppermost curve, marked with a triangle (corresponding to Extended Uniform), shows a quadratic functional correlation of y=1.4524E-05x²+9.6221E-05x, and also shows a nearly linear trend. This means that the pore structure of the medium is very uniform and straight.

On the other hand, the lowermost curve (corresponding to the Extended Complex), marked with a square, shows a quadratic functional correlation of y=2.3918E-04x²-4.8417E-05x, and shows about “0” Darcy at “20%” porosity. It is analyzed to have a very complex, irregular, and tortuous porosity structure.

The quadratic functional interpolation method is explained as follows. When the second term coefficient, 1.2736E-04, of the reference function and the second term coefficient, 1.4524E-05, of the “Extended Uniform” curve are added and then divided by 2 to obtain the average, the second term coefficient of the Y-direction curve becomes 7.0942E-05. In addition, when the first term coefficient, 2.3925E-05, of the reference function and the first term coefficient, 9.6221E-05, of the “Extended Uniform” curve are added and then divided by 2 to obtain the average, the first term coefficient of the Y-direction curve becomes 6.0073E-05.

When the second term coefficient, 1.2736E-04, of the reference function and the second term coefficient, 2.3918E-04, of the “Extended Complex” curve are added and then divided by 2 to obtain the average, the second term coefficient of the X-direction curve becomes 1.8331E-04. In addition, when the first term coefficient, 2.3925E-05, of the reference function and the first term coefficient, −4.8417E-05, of the “Extended Complex” curve are added and then divided by 2 to obtain the average, the first term coefficient of the X-direction curve becomes −1.2257E-05.

In this way, by repeatedly performing the quadratic function interpolation, the permeability for the geometric change of the well can be estimated through a graph selected based on the initial porosity-permeability relationship in all oil fields.

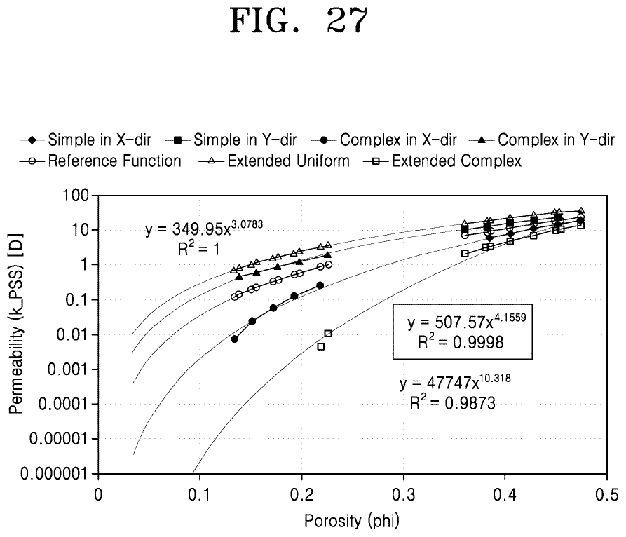

Referring to FIG. 27, the correlation between the porosity and the permeability is shown. Using the corresponding superficial effective diameters, a power-law functional correlation curves of permeability to porosity can be generated. FIG. 27 shows the power-law functional aspects of permeability with respect to porosity variations, which has been widely accepted in prior studies. The reference function indicated by yellow circles indicates a power-law functional correlation of y=507.57x^{4.1559}. The uppermost curve indicated by triangles (corresponding to Extended Uniform) indicates a power-law functional correlation of y=349.95x^{3.0783}. The lowermost curve indicated by squares (corresponding to Extended Complex) indicates a power-law functional correlation of y=47747x^{10.318}. Here, in the power-law functional correlations, x represents porosity and y represents permeability.

Hereinafter, changes in the form of the function according to porosity changes is described.

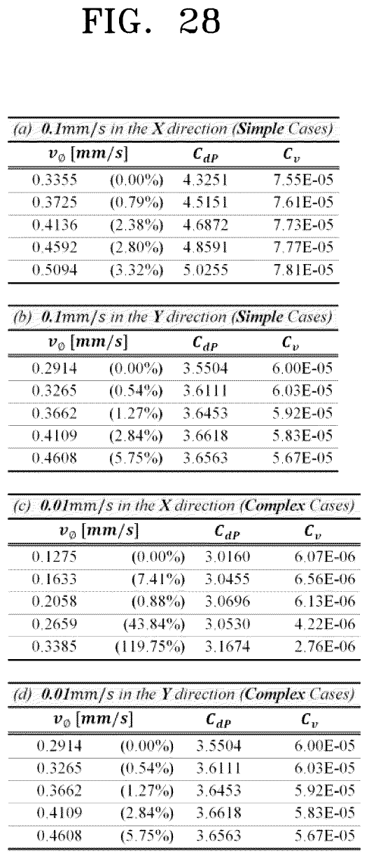

FIG. 28 is a table showing pressure difference constant and interstitial flow velocity constant for interstitial flow velocity in the method for predicting permeability according to geometrical change in a porous medium, according to an embodiment of the present invention.

Referring to FIG. 28, two interesting aspects of the change in the geometry of the pore are revealed. Here, a pressure difference constant (C^{dP}) and an interstitial flow velocity constant (Cᵥ) are defined in Equation 6.

$$\begin{matrix}〈 Equation 6 〉 & \\ ∴ Δ {P}_{Φ} \approx {C}_{{dp}_{( A )}}^{\frac{1}{Φ}} & ( a )\end{matrix}$$

$$∴ {C}_{dp} = Δ {P}^{Φ} \approx constant \& {C}_{{dp}_{( A )}} : {C}_{dp} of each initial status$$

$$∴ {υ}_{Φ} \approx \frac{{C}_{{υ}_{( A )}}}{{Φ}^{0.5}}$$

$$∵ {C}_{υ} = υ \cdot {Φ}^{0.5} \approx constant \& {C}_{{υ}_{( A )}} : {C}_{υ} of each initial status \qquad ( b )$$

In Equation 6, ΔP_{φ} is pressure difference, v_{φ} is an interstitial flow velocity, C_{dP} is a pressure difference constant, and Cᵥ is an interstitial flow velocity constant.

In Equation 6, when the pressure difference constant and the interstitial flow velocity constant are hardly changed to a level that can be considered constant, that is, C_{dP}=ΔP^{φ}≈constant, and Cᵥ=v φ^{0.5}≈constant, it becomes easy to predict the actual change in permeability. As shown in Equation 6, the pressure difference is a function of only the constant (C_{dP(A)}) and the porosity (φ) for the family materials, and the interstitial flow velocity (v_{φ}) is a function of only another constant (Cᵥ) and the porosity (φ).

From the results of FIG. 28, it can be seen that in the model composed by combining the simple porous medium model and the complex porous medium model with the X-direction and Y-direction, even when the internal flow velocity (v_{φ}) changes, the pressure difference constant (C_{dP}) and the interstitial flow velocity constant (Cᵥ) show uniform values that are almost constant. Here, the internal flow velocity changes corresponding to the “thickest model”, “thick model”, “base model”, “thin model”, and “thinnest model”.

Equation 6 can be used for reference only in cases where there is a relatively short period of time or when there is little change in the oil well. Since the measurement results in the actual field have a very large error, it is important to review the validity of the data, and in this case, the relationship of Equation 6 can be used to verify the validity of the data or for very approximate estimation.

In the case where the quadratic function relationship of the superficial diameter derived according to the technical idea of the present invention is utilized to apply it to the production characteristics of an actual reservoir, for example, when measuring initial production data in order to show the relationship between the porosity and the superficial effective diameter of FIG. 24 or FIG. 25 in an actual field, in the case of the measured values in an actual field, it may be quite difficult to measure accurate data due to the characteristics of a vast and complex oil/gas reservoir layer several kilometers long.

In such cases, a method may be needed to determine the reliability of the measured data, the validity of the data available in FIG. 24 or FIG. 25. Here, the relationship of Equation 6 can be usefully utilized to determine the validity of the data.

For reference, FIGS. 24 and 25 are models, maintaining the simple porous medium model of FIG. 2 and the basic structure of each medium, that can be comprehensively applied to the shape change of the complex porous medium model of FIG. 3 considering the debris particles according to the reduction of the stratum (height).

On the other hand, in order to apply this “quadratic function relationship with ‘0’ intercept”, actual measurement or prediction data for at least two points are required, and there is a limitation that reliable results can be obtained only when the change in porosity is sufficiently large. Therefore, when trying to derive a quadratic function relationship using data measured in an actual field, verification (at least a trend review) is required to determine whether the measured values are valid and reliable data.

Here, it is expected that Equation 6(b) can be utilized as a very useful basis for judgment. In addition, since the internal flow velocity can be approximately estimated, it can be utilized as a method for estimating geometric changes when the exact flow velocity value is known, or as a criterion for estimating changes in the flow velocity even when the exact flow velocity is not known.

In addition, when additional data cannot be measured, it is possible to approximate the characteristics of pressure (permeability) and flow rate changes due to geometric (porosity) changes simply through the relationship of Equation 6.

Referring to FIG. 28, the relationship of Equation 6(b) does not seem to properly consider additional changes (complex cases) due to debris particles, but it is expected to provide considerably useful information in cases where the same medium undergoes geometric changes (porosity reduction) due only to changes in stratum stress.

This is unlikely to be reliable for long-term strata changes, but it is expected to provide useful information for relatively small geometric changes (short periods). Therefore, when the initial measurement values (pressure and flow rate) are provided, the change in physical quantities due to short-term geometric changes can be approximately estimated using Equation 6.

The Kozeny-Carman equation is used to deduce the remaining definable key variables and to obtain more accurate and universal correlations for permeability variation analyses. The effective tortuosity and effective diameter of porous media are deduced, and the Kozeny-Carman equation is improved using the effective variables. Subsequently, the correlations of each definable key geometric variable are investigated via pore-scale simulation analyses for various porous medium models. From the changed permeability and superficial diameter correlations with porosity, it is confirmed that the porosity is the most fundamental property quantitatively governing permeability and the hydraulic tortuosity is another fundamental property that makes qualitative differences (variation features). Note that the correlations can be defined as the sole functions of the porosity for each material. However, their individual variation slopes are characterized by each flow direction (path structures).

Herein, the present invention provides several valuable functional aspects of the superficial diameter with porosity change, such as quadratic functional correlations, parallel shifts for each flow path, and less sensitive variations in low porosity ranges. Consequently, the present invention provides that permeability variations can be more precisely and generally estimated using the quadratic correlations of the superficial diameter with porosity changes.

When a measurement is performed at least two points for a well in the field, the permeability according to the porosity can be predicted through the superficial effective diameter by a quadratic function with an intercept of zero. In this way, the production of shale gas can be predicted for at least 20 years in the future.

In addition, after calculating the quadratic function behavior of a first well in the field, it can be predicted that a second well will also have the same quadratic function behavior as the first well, assuming that the formation is the same as that of the first well.

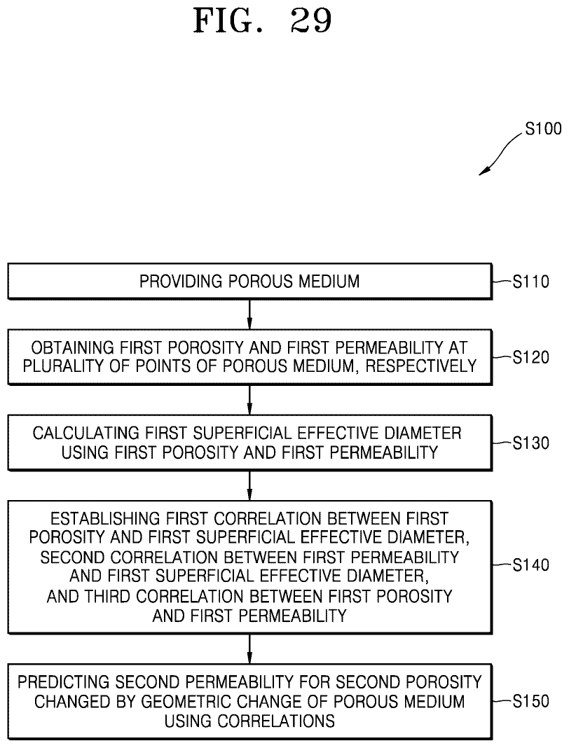

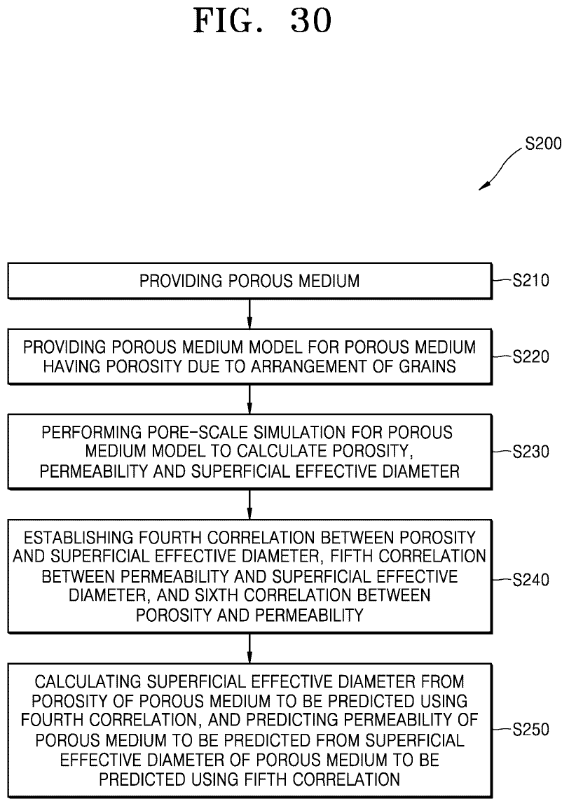

FIGS. 29 and 30 are flowcharts of a method for predicting permeability according to geometrical change in a porous medium, according to an embodiment of the present invention.

Referring to FIG. 29, the method (S100) for predicting permeability according to geometrical change in a porous medium may include providing a porous medium (S110); obtaining a first porosity and a first permeability at the plurality of points of the porous medium, respectively (S120); calculating a first superficial effective diameter using the first porosity and the first permeability (S130); establishing a first correlation between the first porosity and the first superficial effective diameter, a second correlation between the first permeability and the first superficial effective diameter, and a third correlation between the first porosity and the first permeability (S140); and predicting a second permeability for a second porosity changed by a geometric change of the porous medium using the correlations (S150).

According to one embodiment of the present invention, the predicting a second permeability may include, calculating a second superficial effective diameter for the second porosity using the first correlation; and calculating a second permeability for the second superficial effective diameter using the second correlation.

According to one embodiment of the present invention, the first porosity, the first permeability, and the first superficial effective diameter may satisfy the following equations:

$$∴ k = \frac{Φ \cdot {D}_{e}^{2} \cdot {T}^{2}}{32}$$

$$or$$

$$k = \frac{Φ \cdot \overline{{D}_{e}} {}^{2}}{32}$$

where k is permeability, φ is porosity, Dₑ is an effective diameter, T is hydraulic tortuosity, and D̅ₑ̅ is a superficial effective diameter.

According to one embodiment of the present invention, the first superficial effective diameter may satisfy the following equation:

$${\overline{D}}_{e} = {D}_{e} \cdot T = {D}_{h} \cdot {( \frac{T}{ξ} )}^{\frac{1}{2}}$$

where D̅ₑ̅ is a superficial effective diameter, Dₑ is an effective diameter, T is hydraulic tortuosity, Dₕ is a hydraulic diameter, and ξ is a friction ratio.

According to one embodiment of the present invention, the effective diameter may satisfy the following equation:

$${D}_{e} = \frac{{D}_{h}}{{( T \cdot ξ )}^{0.5}}$$

where Dₑ is an effective diameter, Dₕ is a hydraulic diameter, T is hydraulic tortuosity, and ξ is a friction ratio.

According to one embodiment of the present invention, the friction ratio may satisfy the following equations:

$$ξ = \frac{{f}_{υ} {Re}_{υ}}{{f}_{e} {Re}_{e}} = \frac{{f}_{υ} {Re}_{υ}}{64}$$

$$∵ {f}_{υ} {Re}_{e} ≡ 64$$

where fᵥ is a friction factor based on v, Reᵥ is a Reynolds number based on v, fₑ is a friction factor based on vₑ, Reₑ is a Reynolds number based on vₑ, v is an interstitial flow velocity, and vₑ is an effective interstitial flow velocity.

According to one embodiment of the present invention, the fₑ and the Reₑ may satisfy the following equations:

$${f}_{e} = \frac{2 {D}_{e}}{{ρ}^{{υ}^{2}}} \frac{Δ P}{{L}_{e}} ,$$

$${Re}_{e} = \frac{ρ υ {D}_{e}}{μ}$$

where Dₑ is an effective diameter, ρ is a fluid density, v is a interstitial flow velocity, ΔP is pressure difference, Lₑ is an actual pore flow length, and μ is a fluid viscosity.

According to one embodiment of the present invention, the interstitial flow velocity and the effective interstitial flow velocity satisfy the following equations:

$$υ = - \frac{2 {D}_{h}^{2}}{μ \cdot {f}_{υ} {Re}_{υ}} \frac{Δ P}{L}$$

$${υ}_{e} = - \frac{2 {D}_{e}^{2}}{μ \cdot {f}_{e} {Re}_{e}} \frac{Δ P}{{L}_{e}}$$

where v is an interstitial flow velocity, Dₕ is a hydraulic diameter, μ is a fluid viscosity, fᵥ is a friction factor based on v, Reᵥ is a Reynolds number based on v, ΔP is pressure difference, L is a porous medium length, vₑ is an effective interstitial flow velocity, Dₑ is an effective diameter, fₑ is a friction factor based on vₑ, Reₑ is a Reynolds number based on vₑ, and Lₑ is an actual pore flow length.

According to one embodiment of the present invention, the first permeability may satisfy the following equation:

$$k = \frac{2 {D}_{h}^{2} \cdot Φ T}{{f}_{υ} {Re}_{υ}} = \frac{Φ \cdot {D}_{h}^{2}}{32} \cdot ( \frac{T}{ξ} )$$

where k is permeability, Dₕ is a hydraulic diameter, φ is porosity, T is hydraulic tortuosity, v is an interstitial flow velocity, fᵥ is a friction factor based on v, Reᵥ is a Reynolds number based on v, and ξ is a friction ratio.

According to one embodiment of the present invention, the first correlation between the first superficial effective diameter and the first porosity may have a quadratic functional correlation.

According to one embodiment of the present invention, the second correlation between the first permeability and the first superficial effective diameter may have a power-law functional correlation, and the third correlation between the first porosity and the first permeability may have a power-law functional correlation.

According to one embodiment of the present invention, the obtaining the first porosity and the first permeability may be performed under a condition that the following equations are satisfied:

$$∴ Δ {P}_{Φ} \approx {C}_{{dp}_{( A} )}^{\frac{1}{Φ}} \qquad ( a )$$

$$∴ {C}_{dp} = Δ {P}^{Φ} \approx constant \& {C}_{{dp}_{( A )}} : {C}_{dp} of each initial status$$

$$∴ {υ}_{Φ} \approx \frac{{C}_{{υ}_{( A )}}}{{Φ}^{0.5}} \qquad ( b )$$

$$∵ {C}_{υ} = υ \cdot {Φ}^{0.5} \approx constant \& {C}_{{υ}_{( A )}} : {C}_{υ} of each initial status$$

where ΔP_{φ} is pressure difference, v_{φ} is an interstitial flow velocity, C_{dP} is a pressure difference constant, and Cᵥ is an interstitial flow velocity constant.

According to one embodiment of the present invention, the first porosity may have a range of 13.4% to 47.4%, and the first permeability has a range of 0.0073 Darcy to 18.3 Darcy.

According to one embodiment of the present invention, a quadratic function interpolation method for the first correlation between the first porosity and the first superficial effective diameter may be performed to obtain family medium correlations between a porosity and a superficial effective diameter for a family medium of the porous medium.

Referring to FIG. 30, the method (S200) for predicting permeability according to geometrical change in a porous medium may include: providing a porous medium (S210); providing a porous medium model for the porous medium having porosity due to the arrangement of grains (S220); performing a pore-scale simulation for the porous medium model to calculate a porosity, a permeability and a superficial effective diameter (S230); establishing a fourth correlation between the porosity and the superficial effective diameter, a fifth correlation between the permeability and the superficial effective diameter, and a sixth correlation between the porosity and the permeability (S240); and calculating a superficial effective diameter from a porosity of a porous medium to be predicted using the fourth correlation, and predicting a permeability of the porous medium to be predicted from the superficial effective diameter of the porous medium to be predicted using the fifth correlation (S250).

According to one embodiment of the present invention, in the performing a pore-scale simulation, the pore-scale simulations may be performed with respect to a first direction in the porous medium model and a second direction in the porous medium model perpendicular to the first direction, respectively, to calculate the porosity, the permeability, and the superficial effective diameter with respect to first direction and the second direction, respectively, wherein in the establishing the fourth correlation, the fourth correlation is established with respect to the first direction and the second direction, respectively, wherein in the establishing the fifth correlation, the fifth correlation is established with respect to the first direction and the second direction, respectively, wherein in the establishing the sixth correlation, the sixth correlation is established with respect to the first direction and the second direction, respectively.

According to one embodiment of the present invention, the establishing the fourth correlation may include establishing a fourth reference correlation corresponding to the average of the fourth correlation with respect to the first direction and the fourth correlation with respect to the second direction, the establishing the fifth correlation may include establishing a fifth reference correlation corresponding to the average of the fifth correlation with respect to the first direction and the fifth correlation with respect to the second direction, and the establishing the sixth correlation may include establishing a sixth reference correlation corresponding to the average of the sixth correlation with respect to the first direction and the sixth correlation with respect to the second direction.

According to one embodiment of the present invention, a quadratic function interpolation method with respect to the fourth reference correlation may be performed to further establish the fourth correlation to be extended in multiple ways with respect to the change in the porosity.

According to one embodiment of the present invention, the porous medium model may consist of a simple porous medium model in which grains of equal size are arranged, wherein the grains have a radius in a range of 45 μm to 55 μm, wherein the simple porous medium model has a crack height in a range of 0.4 mm to 0.5 mm and porosity in a range of 36% to 47.5%.

According to one embodiment of the present invention, the porous medium model may consist of a complex porous medium model in which grains of different sizes are arranged, wherein the grains of different sizes are arranged staggered with each other, wherein the grains have a radius in a range of 30 μm to 55 μm, wherein the complex porous medium model has a crack height in a range of 0.4 mm to 0.5 mm and porosity in a range of 13.3% to 22.6%.

The technical spirit of the present invention described above is not limited to the foregoing embodiments and the accompanying drawings, and it will be clear to those skilled in the art to which the present invention pertains that various substitutions, modifications and changes are possible within the scope of the technical spirit of the present invention.

### NOMENCLATURE

C: Constant,
C_{K}: Kozeny Constant,
C_{S}: Shape Constant of Cross Section,
D: Diameter,
Dₘ: Grain D,
Dₕ: Hydraulic D,
Dₑ: Effective D,
D̅ₑ̅: Superficial Dₑ,
f: Friction Factor,
fᵥ: f defined by True v,
k: Permeability,

$$k = \frac{\text{?}}{\text{?}}$$

$$at$$

$$u = - \frac{k}{μ} \frac{Δ P}{L}$$

$$\text{?} \text{indicates text missing or illegible when filed}$$

L: Medium Length,
Lₑ: Actual pore flow length,
P: Pressure,
ΔP: Pressure Difference,
Re: Reynolds Number,
Reᵥ: Re defined for v,
Rₕ: Hydraulic Radius (Dₕ: =4Rₕ),
S: Surface Area,
S_{S}: Specific Surface Area,
T: Tortuosity (T=L/Lₑ),
Tₑ*: Effective T,
u: Apparent Flow Velocity through a Medium,
v: True Internal Velocity through Real Pores,
vₛ=u/φ: Superficial v for Straight Path,
x, y, z: Directions & Axes in x-, y-, and z-directions,
ξ: Friction Ratio,

$$ξ = \frac{\text{?}}{64} \& {C}_{K} = 2 ξ$$

$$\text{?} \text{indicates text missing or illegible when filed}$$

μ: Fluid Viscosity,
ρ: Fluid Density,
φ: Porosity,

### Super-Script & Sub-Script

C: Carman, k_{C}: Carman's k,
e: Real (Lₑ), Effective (Dₑ, Tₑ*, vₑ, fₑReₑ),
h: Hydraulic (Dₕ),
K: Kozeny, k_{K}: Kozeny's k, f_{K}: Kozeny's f,
s: Superficial (vₛ=u/φ), Specific (S_{S}),
u: Apparent Medium Flow Velocity,
v: Average Interstitial Flow Velocity,

### <Special Hydraulic Cylinder Model>

*:

$${L}_{e}^{*} \neq {L}_{e} ,$$

$${v}_{e}^{*} \neq v ,$$

$${T}_{e}^{*} = \frac{L}{{L}_{e}^{*}} = \frac{1}{{ξ}^{*}} \neq T$$

1. A method for predicting permeability according to geometrical change in a porous medium, comprising:
providing a porous medium;
obtaining a first porosity and a first permeability at a plurality of points of the porous medium, respectively;
calculating a first superficial effective diameter using the first porosity and the first permeability;
establishing a first correlation between the first porosity and the first superficial effective diameter, a second correlation between the first permeability and the first superficial effective diameter, and a third correlation between the first porosity and the first permeability; and
predicting a second permeability for a second porosity changed by a geometric change of the porous medium using the correlations.

2. The method for predicting permeability according to geometrical change in the porous medium according to claim 1, wherein the predicting a second permeability comprises:
calculating a second superficial effective diameter for the second porosity using the first correlation; and
calculating a second permeability for the second superficial effective diameter using the second correlation.

3. The method for predicting permeability according to geometrical change in the porous medium according to claim 1, wherein the first porosity, the first permeability, and the first superficial effective diameter satisfy the following equations:
$$∴ k = \frac{Φ \cdot {D}_{e}^{2} \cdot {T}^{2}}{32}$$
$$or$$
$$k = \frac{Φ \cdot \overline{{D}_{e}} {}^{2}}{32}$$
where k is permeability, φ is porosity, Dₑ is an effective diameter, T is hydraulic tortuosity, and D̅ₑ̅ is a superficial effective diameter.

4. The method for predicting permeability according to geometrical change in the porous medium according to claim 3, wherein the first superficial effective diameter satisfies the following equation:
$$\overline{{D}_{e}} = {D}_{e} \cdot T = {D}_{h} \cdot {( \frac{T}{ξ} )}^{\frac{1}{2}}$$
where D̅ₑ̅ is a superficial effective diameter, Dₑ is an effective diameter, T is hydraulic tortuosity, Dₕ is a hydraulic diameter, and ξ is a friction ratio.

5. The method for predicting permeability according to geometrical change in the porous medium according to claim 3, wherein the effective diameter satisfies the following equation:
$${D}_{e} = \frac{{D}_{h}}{{( T \cdot ξ )}^{0.5}}$$
where Dₑ is an effective diameter, Dₕ is a hydraulic diameter, T is hydraulic tortuosity, and ξ is a friction ratio.

6. The method for predicting permeability according to geometrical change in the porous medium according to claim 4, wherein the friction ratio satisfies the following equations:
$$ξ = \frac{{f}_{υ} {Re}_{υ}}{{f}_{e} {Re}_{e}} = \frac{{f}_{υ} {Re}_{υ}}{64}$$
$$∵ {f}_{υ} {Re}_{e} ≡ 64$$
where fᵥ is a friction factor based on v, Reᵥ is a Reynolds number based on v, fₑ is a friction factor based on vₑ, Reₑ is a Reynolds number based on vₑ, v is an interstitial flow velocity, and vₑ is an effective interstitial flow velocity.

7. The method for predicting permeability according to geometrical change in the porous medium according to claim 6, wherein the fₑ and the Reₑ satisfy the following equations:
$${f}_{e} = \frac{2 {D}_{e}}{{ρ}^{{υ}^{2}}} \frac{Δ P}{{L}_{e}} ,$$
$${Re}_{e} = \frac{ρ υ {D}_{e}}{μ}$$
where Dₑ is an effective diameter, ρ is a fluid density, v is an interstitial flow velocity, ΔP is pressure difference, Lₑ is an actual pore flow length, and μ is a fluid viscosity.

8. The method for predicting permeability according to geometrical change in the porous medium according to claim 6, wherein the interstitial flow velocity and the effective interstitial flow velocity satisfy the following equations:
$$υ = - \frac{2 {D}_{h}^{2}}{μ \cdot {f}_{υ} {Re}_{υ}} \frac{Δ P}{L}$$
$${υ}_{e} = - \frac{2 {D}_{e}^{2}}{μ \cdot {f}_{e} {Re}_{e}} \frac{Δ P}{{L}_{e}}$$
where v is an interstitial flow velocity, Dₕ is a hydraulic diameter, μ is a fluid viscosity, fᵥ is a friction factor based on v, Reᵥ is a Reynolds number based on v, ΔP is pressure difference, L is a porous medium length, vₑ is an effective interstitial flow velocity, Dₑ is an effective diameter, fₑ is a friction factor based on vₑ, Reₑ is a Reynolds number based on vₑ, and Lₑ is an actual pore flow length.

9. The method for predicting permeability according to geometrical change in the porous medium according to claim 1, wherein the first permeability satisfies the following equation:
$$k = \frac{2 {D}_{h}^{2} \cdot Φ T}{{f}_{υ} {Re}_{υ}} = \frac{Φ \cdot {D}_{h}^{2}}{32} \cdot ( \frac{T}{ξ} )$$
where k is permeability, Dₕ is a hydraulic diameter, φ is porosity, T is hydraulic tortuosity, v is an interstitial flow velocity, fᵥ is a friction factor based on v, Reᵥ is a Reynolds number based on v, and ξ is a friction ratio.

10. The method for predicting permeability according to geometrical change in the porous medium according to claim 1, wherein the first correlation between the first superficial effective diameter and the first porosity has a quadratic functional correlation.

11. The method for predicting permeability according to geometrical change in the porous medium according to claim 1, wherein the second correlation between the first permeability and the first superficial effective diameter has a power-law functional correlation,
wherein the third correlation between the first porosity and the first permeability has a power-law functional correlation.

12. The method for predicting permeability according to geometrical change in the porous medium according to claim 1, wherein the obtaining the first porosity and the first permeability is performed under a condition that the following equations are satisfied:
$$∴ Δ {P}_{Φ} \approx {C}_{{dp}_{( A} )}^{\frac{1}{Φ}} \qquad ( a )$$
$$∴ {C}_{dp} = Δ {P}^{Φ} \approx constant \& {C}_{{dp}_{( A )}} : {C}_{dp} of each initial status$$
$$∴ {υ}_{Φ} \approx \frac{{C}_{{υ}_{( A )}}}{{Φ}^{0.5}} \qquad ( b )$$
$$∵ {C}_{υ} = υ \cdot {Φ}^{0.5} \approx constant \& {C}_{{υ}_{( A )}} : {C}_{υ} of each initial status$$
where ΔP_{φ} is pressure difference, v_{φ} is an interstitial flow velocity, C_{dP} is a pressure difference constant, and Cᵥ is an interstitial flow velocity constant.

13. The method for predicting permeability according to geometrical change in the porous medium according to claim 1, wherein the first porosity has a range of 13.4% to 47.4%, and the first permeability has a range of 0.0073 Darcy to 18.3 Darcy.

14. The method for predicting permeability according to geometrical change in the porous medium according to claim 1, wherein a quadratic function interpolation method for the first correlation between the first porosity and the first superficial effective diameter is performed to obtain family medium correlation between a porosity and a superficial effective diameter for a family medium of the porous medium.

15. A method for predicting permeability according to geometrical change in a porous medium, comprising:
providing a porous medium;
providing a porous medium model for the porous medium having porosity due to an arrangement of grains;
performing a pore-scale simulation for the porous medium model to calculate a porosity, a permeability and a superficial effective diameter;
establishing a fourth correlation between the porosity and the superficial effective diameter, a fifth correlation between the permeability and the superficial effective diameter, and a sixth correlation between the porosity and the permeability; and
calculating a superficial effective diameter from a porosity of a porous medium to be predicted using the fourth correlation, and predicting a permeability of the porous medium to be predicted from the superficial effective diameter of the porous medium to be predicted using the fifth correlation.

16. The method for predicting permeability according to geometrical change in the porous medium according to claim 15, wherein in the performing a pore-scale simulation, the pore-scale simulations are performed with respect to a first direction in the porous medium model and a second direction in the porous medium model perpendicular to the first direction, respectively, to calculate the porosity, the permeability, and the superficial effective diameter with respect to first direction and the second direction, respectively,
wherein in the establishing the fourth correlation, the fourth correlation is established with respect to the first direction and the second direction, respectively,
wherein in the establishing the fifth correlation, the fifth correlation is established with respect to the first direction and the second direction, respectively,
wherein in the establishing the sixth correlation, the sixth correlation is established with respect to the first direction and the second direction, respectively.

17. The method for predicting permeability according to geometrical change in the porous medium according to claim 16, wherein the establishing the fourth correlation comprises establishing a fourth reference correlation corresponding to an average of the fourth correlation with respect to the first direction and the fourth correlation with respect to the second direction,
wherein the establishing the fifth correlation comprises establishing a fifth reference correlation corresponding to the average of the fifth correlation with respect to the first direction and the fifth correlation with respect to the second direction,
wherein the establishing the sixth correlation comprises establishing a sixth reference correlation corresponding to the average of the sixth correlation with respect to the first direction and the sixth correlation with respect to the second direction.

18. The method for predicting permeability according to geometrical change in the porous medium according to claim 17, wherein a quadratic function interpolation method with respect to the fourth reference correlation is performed to further establish the fourth correlation to be extended in multiple ways with respect to the change in the porosity.

19. The method for predicting permeability according to geometrical change in the porous medium according to claim 15, wherein the porous medium model consists of a simple porous medium model in which grains of equal size are arranged,
wherein the grains have a radius in a range of 45 μm to 55 μm,
wherein the simple porous medium model has a crack height in a range of 0.4 mm to 0.5 mm and porosity in a range of 36% to 47.5%.

20. The method for predicting permeability according to geometrical change in the porous medium according to claim 15, wherein the porous medium model consists of a complex porous medium model in which grains of different sizes are arranged,
wherein the grains of different sizes are arranged staggered with each other,
wherein the grains have a radius in a range of 30 μm to 55 μm,
wherein the complex porous medium model has a crack height in a range of 0.4 mm to 0.5 mm and porosity in a range of 13.3% to 22.6%.
